(19) United States
(12) Patent Application Publication
(10) Pub. No.: US 2026/0181599 A1
(43) Pub. Date: Jun. 25, 2026

(54) LOW POWER SUPERIMPOSED SENSING TRANSMISSIONS FOR EFFICIENT JOINT COMMUNICATION AND SENSING

(71) Applicant: QUALCOMM Incorporated, San Diego, CA (US)

(72) Inventors: Stelios STEFANATOS, San Diego, CA (US); Shijun WU, San Diego, CA (US); Preeti KUMARI, San Diego, CA (US); Kapil GULATI, Belle Mead, NJ (US); Junyi LI, Fairless Hills, PA (US); Sony AKKARAKARAN, Poway, CA (US)

(21) Appl. No.: 19/125,692

(22) PCT Filed: Dec. 4, 2023
(86) PCT No.: PCT/US2023/082247

§ 371 Date: Apr. 29, 2025

(30) Foreign Application Priority Data
Dec. 19, 2022 (GR) 20220101053

(51) Int. Cl. H04W 72/044; H04W 72/25

(52) U.S. Cl. CPC H04W 72/044; H04W 72/25

(57) ABSTRACT

Methods, systems, and devices for wireless communications are described. For instance, a first user equipment (UE) may receive first sidelink control information (SCI) indicating that a second UE has selected a first set of time-frequency resources from a sidelink resource pool for transmitting a first signal associated with sidelink communication. The first UE may transmit, subsequent to receiving the first SCI, second SCI indicating that the first UE has selected a second set of time-frequency resources from the sidelink resource pool for transmitting a second signal associated with sensing, where the second set of time-frequency resources at least partially overlap with the first set of quency resources. The first UE may transmit the second signal using the second set of time-frequency resources based on transmitting the second SCI. A third UE may perform interference cancellation on the second signal over the second set of time-frequency resources to receive other signals associated with sidelink communication.

### CROSS REFERENCE

The present Application is a 371 national stage filing of International PCT Application No. PCT/US2023/082247 by STEFANATOS et al., entitled “LOW POWER SUPERIMPOSED SENSING TRANSMISSIONS FOR EFFICIENT JOINT COMMUNICATION AND SENSING,” filed Dec. 4, 2023; and claims priority to and the benefit of Greek Patent Application No. 20220101053 by STEFANATOS et al., entitled “LOW POWER SUPERIMPOSED SENSING TRANSMISSIONS FOR EFFICIENT JOINT COMMUNICATION AND SENSING,” filed Dec. 19, 2022, each of which is assigned to the assignee hereof, and each of which is expressly incorporated by reference herein.

### FIELD OF TECHNOLOGY

The following relates to wireless communications, including low power superimposed sensing transmissions for efficient joint communication and sensing.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may receive multiple transmissions over the same time and frequency resources. Since the multiple transmissions are received over the same time and frequency resources, these transmissions may interfere with each other and may limit an ability of the UE to successfully receive and decode these transmissions. Accordingly, techniques that limit interference may increase the efficiency of wireless communications.

### SUMMARY

The described techniques relate to improved methods, systems, devices, and apparatuses that support low power superimposed sensing transmissions for efficient joint communication and sensing. For example, the described techniques provide for signals associated with sidelink communication and signals associated with sensing to overlap in at least some cases while limiting interference between them. For instance, a first user equipment (UE) may receive first sidelink control information (SCI) indicating that a second UE has selected a first set of time-frequency resources from a sidelink resource pool for transmitting a first signal associated with sidelink communication. The first UE may transmit, subsequent to receiving the first SCI, second SCI indicating that the first UE has selected a second set of time-frequency resources from the sidelink resource pool for transmitting a second signal associated with sensing, where the second set of time-frequency resources at least partially overlap with the first set of time-frequency resources. The first UE may transmit the second signal using the second set of time-frequency resources based on transmitting the second SCI. A third UE may perform interference cancellation on the second signal over the second set of time-frequency resources to receive other signals associated with sidelink communication.

A method for wireless communication at a first user equipment (UE) is described. The method may include receiving first sidelink control information indicating that a second UE has selected a first set of time-frequency resources from a sidelink resource pool for transmitting a first signal associated with sidelink communication, transmitting, subsequent to receiving the first sidelink control information, second sidelink control information indicating that the first UE has selected a second set of time-frequency resources from the sidelink resource pool for transmitting a second signal associated with sensing, where the second set of time-frequency resources at least partially overlap with the first set of time-frequency resources, and transmitting the second signal using the second set of time-frequency resources based on transmitting the second sidelink control information.

An apparatus for wireless communication at a first UE is described. The apparatus may include a processor, memory coupled with the processor, and instructions stored in the memory. The instructions may be executable by the processor to cause the apparatus to receive first sidelink control information indicating that a second UE has selected a first set of time-frequency resources from a sidelink resource pool for transmitting a first signal associated with sidelink communication, transmit, subsequent to receiving the first sidelink control information, second sidelink control information indicating that the first UE has selected a second set of time-frequency resources from the sidelink resource pool for transmitting a second signal associated with sensing, where the second set of time-frequency resources at least partially overlap with the first set of time-frequency resources, and transmit the second signal using the second set of time-frequency resources based on transmitting the second sidelink control information.

Another apparatus for wireless communication at a first UE is described. The apparatus may include means for receiving first sidelink control information indicating that a second UE has selected a first set of time-frequency resources from a sidelink resource pool for transmitting a first signal associated with sidelink communication, means for transmitting, subsequent to receiving the first sidelink control information, second sidelink control information indicating that the first UE has selected a second set of time-frequency resources from the sidelink resource pool for transmitting a second signal associated with sensing, where the second set of time-frequency resources at least partially overlap with the first set of time-frequency resources, and means for transmitting the second signal using the second set of time-frequency resources based on transmitting the second sidelink control information.

A non-transitory computer-readable medium storing code for wireless communication at a first UE is described. The code may include instructions executable by a processor to receive first sidelink control information indicating that a second UE has selected a first set of time-frequency resources from a sidelink resource pool for transmitting a first signal associated with sidelink communication, transmit, subsequent to receiving the first sidelink control information, second sidelink control information indicating that the first UE has selected a second set of time-frequency resources from the sidelink resource pool for transmitting a second signal associated with sensing, where the second set of time-frequency resources at least partially overlap with the first set of time-frequency resources, and transmit the second signal using the second set of time-frequency resources based on transmitting the second sidelink control information.

In some examples of the method, apparatuses, and non-transitory computer-readable medium described herein, randomly selecting, for the second set of time-frequency resources, a first time-frequency resource of the first set of time-frequency resources.

In some examples of the method, apparatuses, and non-transitory computer-readable medium described herein, the first time-frequency resource may be selected for the second set of time-frequency resources based on a total number of monitored and non-reserved resources within a resource window associated with the sidelink resource pool being below a threshold.

Some examples of the method, apparatuses, and non-transitory computer-readable medium described herein may further include operations, features, means, or instructions for selecting, for the second set of time-frequency resources, a first time-frequency resource of the first set of time-frequency resources based on the first time-frequency resource being associated with a reference signal received power above a threshold power, a total duration of the first time-frequency resource overlapping with a total duration of the second set of time-frequency resources for less than a threshold amount of slots or symbols, or both.

Some examples of the method, apparatuses, and non-transitory computer-readable medium described herein may further include operations, features, means, or instructions for receiving third sidelink control information indicating that the second UE or a third UE may have selected a third set of time-frequency resources from the sidelink resource pool for transmitting a third signal associated with sensing, selecting, for a fourth set of time-frequency resources, a second time-frequency resource of the third set of time-frequency resources, transmitting fourth sidelink control information indicating that the first UE may have selected the fourth set of time-frequency resources from the sidelink resource pool for transmitting a fourth signal associated with sidelink communication, and transmitting the fourth signal using the fourth set of time-frequency resources.

Some examples of the method, apparatuses, and non-transitory computer-readable medium described herein may further include operations, features, means, or instructions for receiving third sidelink control information indicating that the second UE or a third UE may have selected a third set of time-frequency resources from the sidelink pool for transmitting a third signal associated with sensing, selecting, for a fourth set of time-frequency resources, a second time-frequency resource excluded from the third set of time-frequency resources based on a congestion level, a priority of a fourth signal associated with sidelink communication, packet delay budget of the fourth signal, an interference level associated with the third sidelink control information, or any combination thereof, transmitting fourth sidelink control information indicating that the first UE may have selected the fourth set of time-frequency resources from the sidelink resource pool for transmitting a fourth signal associated with sidelink communication, and transmitting the fourth signal using the fourth set of time-frequency resources.

Some examples of the method, apparatuses, and non-transitory computer-readable medium described herein may further include operations, features, means, or instructions for receiving third sidelink control information indicating that that a third UE may have selected a third set of time-frequency resources for transmitting a third signal associated with sensing, the second set of time-frequency resources excluding each resource of the third set of time-frequency resources based on receiving the third sidelink control information.

Some examples of the method, apparatuses, and non-transitory computer-readable medium described herein may further include operations, features, means, or instructions for receiving third sidelink control information indicating that a third UE may have selected a third set of time-frequency resources for transmitting a third signal associated with sensing, the second set of time-frequency resources including a first time-frequency resource of the third set of time-frequency resources based on less than a threshold percentage of the time-frequency resources of the third set of time-frequency resources overlapping with the time-frequency resources of the second set of time-frequency resources, the third set of time-frequency resources being associated with a reference signal received power below a threshold power, or both.

Some examples of the method, apparatuses, and non-transitory computer-readable medium described herein may further include operations, features, means, or instructions for selecting a waveform for the second signal associated with the sensing from a preconfigured set of waveforms based on selecting a first time-frequency resource of the first set of time-frequency resources, where the second signal may be transmitted with the selected waveform.

Some examples of the method, apparatuses, and non-transitory computer-readable medium described herein may further include operations, features, means, or instructions for generating a first waveform over multiple slots for the second signal associated with sensing by repeating a second waveform configured over a single slot and based on selecting a first time-frequency resource of the first set of time-frequency resources, where the second signal may be transmitted based on generating the first waveform.

In some examples of the method, apparatuses, and non-transitory computer-readable medium described herein, the second sidelink control information includes a time resource indication value field, a frequency resource indication value field, or both indicating a first time-frequency resource of the first set of time-frequency resources.

In some examples of the method, apparatuses, and non-transitory computer-readable medium described herein, the time resource indication value field, the frequency resource indication value field, or both includes an indication of whether the first time-frequency resource may be reserved or available for a transmission distinct from the second signal associated with sensing.

In some examples of the method, apparatuses, and non-transitory computer-readable medium described herein, the second set of time-frequency resources includes a first time-frequency resource of the first set of time-frequency resources based on a duration associated with the second signal satisfying a first threshold, a power associated with the second signal satisfying a second threshold, or both.

A method for wireless communication at a first UE is described. The method may include receiving first sidelink control information indicating that a second UE has selected a first set of time-frequency resources from a sidelink resource pool for transmitting a first signal associated with sidelink communication and transmitting, subsequent to receiving the first sidelink control information, a second signal associated with sensing using a second set of time-frequency resources of the sidelink resource pool, where the second set of time-frequency resources at least partially overlap with the first set of time-frequency resources, and where selecting the second set of time-frequency resources is based on a metric associated with the first time-frequency resources.

An apparatus for wireless communication at a first UE is described. The apparatus may include a processor, memory coupled with the processor, and instructions stored in the memory. The instructions may be executable by the processor to cause the apparatus to receive first sidelink control information indicating that a second UE has selected a first set of time-frequency resources from a sidelink resource pool for transmitting a first signal associated with sidelink communication and transmit, subsequent to receiving the first sidelink control information, a second signal associated with sensing using a second set of time-frequency resources of the sidelink resource pool, where the second set of time-frequency resources at least partially overlap with the first set of time-frequency resources, and where selecting the second set of time-frequency resources is based on a metric associated with the first time-frequency resources.

Another apparatus for wireless communication at a first UE is described. The apparatus may include means for receiving first sidelink control information indicating that a second UE has selected a first set of time-frequency resources from a sidelink resource pool for transmitting a first signal associated with sidelink communication and means for transmitting, subsequent to receiving the first sidelink control information, a second signal associated with sensing using a second set of time-frequency resources of the sidelink resource pool, where the second set of time-frequency resources at least partially overlap with the first set of time-frequency resources, and where selecting the second set of time-frequency resources is based on a metric associated with the first time-frequency resources.

A non-transitory computer-readable medium storing code for wireless communication at a first UE is described. The code may include instructions executable by a processor to receive first sidelink control information indicating that a second UE has selected a first set of time-frequency resources from a sidelink resource pool for transmitting a first signal associated with sidelink communication and transmit, subsequent to receiving the first sidelink control information, a second signal associated with sensing using a second set of time-frequency resources of the sidelink resource pool, where the second set of time-frequency resources at least partially overlap with the first set of time-frequency resources, and where selecting the second set of time-frequency resources is based on a metric associated with the first time-frequency resources.

In some examples of the method, apparatuses, and non-transitory computer-readable medium described herein, randomly selecting, for the second set of time-frequency resources, a first time-frequency resource of the first set of time-frequency resources.

In some examples of the method, apparatuses, and non-transitory computer-readable medium described herein, the first time-frequency resource may be selected for the second set of time-frequency resources based on a total number of monitored and non-reserved resources within a resource window associated with the sidelink resource pool being below a threshold.

Some examples of the method, apparatuses, and non-transitory computer-readable medium described herein may further include operations, features, means, or instructions for selecting, for the second set of time-frequency resources, a first time-frequency resource of the first set of time-frequency resources based on the first time-frequency resource being associated with a reference signal received power above a threshold power, a total duration of the first set of time-frequency resources overlapping with a total duration of the second set of time-frequency resources for less than a threshold amount of slots or symbols, or both.

A method for wireless communication at a first UE is described. The method may include receiving first sidelink control information indicating that a second UE has selected a first time-frequency resource for transmitting a first signal associated with sidelink communication, receiving second sidelink control information indicating that a third UE has selected at least the first time-frequency resource for transmitting a second signal associated with sensing, and performing interference cancellation on the second signal associated with sensing to receive the first signal associated with sidelink communication over the first time-frequency resource based on receiving the second sidelink control information indicating that the third UE has selected the first time-frequency resource.

An apparatus for wireless communication at a first UE is described. The apparatus may include a processor, memory coupled with the processor, and instructions stored in the memory. The instructions may be executable by the processor to cause the apparatus to receive first sidelink control information indicating that a second UE has selected a first time-frequency resource for transmitting a first signal associated with sidelink communication, receive second sidelink control information indicating that a third UE has selected at least the first time-frequency resource for transmitting a second signal associated with sensing, and perform interference cancellation on the second signal associated with sensing to receive the first signal associated with sidelink communication over the first time-frequency resource based on receiving the second sidelink control information indicating that the third UE has selected the first time-frequency resource.

Another apparatus for wireless communication at a first UE is described. The apparatus may include means for receiving first sidelink control information indicating that a second UE has selected a first time-frequency resource for transmitting a first signal associated with sidelink communication, means for receiving second sidelink control information indicating that a third UE has selected at least the first time-frequency resource for transmitting a second signal associated with sensing, and means for performing interference cancellation on the second signal associated with sensing to receive the first signal associated with sidelink communication over the first time-frequency resource based on receiving the second sidelink control information indicating that the third UE has selected the first time-frequency resource.

A non-transitory computer-readable medium storing code for wireless communication at a first UE is described. The code may include instructions executable by a processor to receive first sidelink control information indicating that a second UE has selected a first time-frequency resource for transmitting a first signal associated with sidelink communication, receive second sidelink control information indicating that a third UE has selected at least the first time-frequency resource for transmitting a second signal associated with sensing, and perform interference cancellation on the second signal associated with sensing to receive the first signal associated with sidelink communication over the first time-frequency resource based on receiving the second sidelink control information indicating that the third UE has selected the first time-frequency resource.

Some examples of the method, apparatuses, and non-transitory computer-readable medium described herein may further include operations, features, means, or instructions for determining a waveform of the second signal associated with sensing from a preconfigured set of waveforms, where performing the interference cancellation may be based on determining the waveform.

In some examples of the method, apparatuses, and non-transitory computer-readable medium described herein, the waveform of the second signal may be configured for a single slot and repeated over multiple slots and performing the interference cancellation may be based on the waveform of the second signal being configured for the single slot and repeated over the multiple slots.

Some examples of the method, apparatuses, and non-transitory computer-readable medium described herein may further include operations, features, means, or instructions for receiving an indication of a set of resources elements for detecting signals associated with sensing and detecting at least one signal associated with sensing over at least one of the set of resource elements, where performing the interference cancellation may be based on detecting the at least one signal associated with sensing over the at least one of the set of resource elements.

In some examples of the method, apparatuses, and non-transitory computer-readable medium described herein, the set of resource elements excludes any resource elements configured for receiving one or more demodulation reference signals of one or more transmissions unassociated with sensing.

In some examples of the method, apparatuses, and non-transitory computer-readable medium described herein, the second sidelink control information includes a time resource indication value field, a frequency resource indication value field, or both indicating the first time-frequency resource.

In some examples of the method, apparatuses, and non-transitory computer-readable medium described herein, the time resource indication value field, the frequency resource indication value field, or both includes an indication of whether the first time-frequency resource may be reserved or available for a transmission distinct from the second signal associated with sensing.

### BRIEF DESCRIPTION OF THE DRAWINGS

FIG. 1 illustrates an example of a wireless communications system that supports low power superimposed sensing transmissions for efficient joint communication and sensing in accordance with one or more aspects of the present disclosure.

FIG. 2 illustrates an example of a wireless communications scheme that supports low power superimposed sensing transmissions for efficient joint communication and sensing in accordance with one or more aspects of the present disclosure.

FIG. 3 illustrates an example of a sidelink resource pool that supports low power superimposed sensing transmissions for efficient joint communication and sensing in accordance with one or more aspects of the present disclosure.

FIG. 4 illustrates an example of a process flow that supports low power superimposed sensing transmissions for efficient joint communication and sensing in accordance with one or more aspects of the present disclosure.

FIG. 5 illustrates an example of a process flow that supports low power superimposed sensing transmissions for efficient joint communication and sensing in accordance with one or more aspects of the present disclosure.

FIGS. 6 and 7 illustrate block diagrams of devices that support low power superimposed sensing transmissions for efficient joint communication and sensing in accordance with one or more aspects of the present disclosure.

FIG. 8 illustrates a block diagram of a communications manager that supports low power superimposed sensing transmissions for efficient joint communication and sensing in accordance with one or more aspects of the present disclosure.

FIG. 9 illustrates a diagram of a system including a device that supports low power superimposed sensing transmissions for efficient joint communication and sensing in accordance with one or more aspects of the present disclosure.

FIGS. 10 through 12 show flowcharts illustrating methods that support enhanced demodulation reference signal for digital post distortion assist in accordance with aspects of the present disclosure.

### DETAILED DESCRIPTION

User equipments (UEs) communicating which each other may perform sidelink communication and may also perform sensing (e.g., radar sensing). If time-frequency resources for sensing overlap with time-frequency resources for performing sidelink communication (e.g., cellular vehicle-to-everything (CV2X) communication), a UE that receives both a corresponding sensing transmission (e.g., a signal associated with sensing) and a corresponding sidelink transmission (e.g., a signal associated with sidelink communication, such as a data message for sidelink communication) may fail to receive and decode the sidelink transmission. However, limiting resources for sensing and resources for sidelink transmissions in all cases may decrease the efficiency of wireless communications.

The methods described herein may enable overlap between resources for sensing and resources for sidelink communications while decreasing, on average, a likelihood that a UE fails to receive a sidelink transmission due to one or more interfering sensing transmissions. For instance, the sensing transmission may be transmitted at a lower power and a longer duration (e.g., over more resources) as compared to the sidelink transmission. However, in some such examples, the interference may be high enough such that receiving both transmissions may result in the UE still failing to receive the sidelink transmission. Accordingly, as described herein, a UE that has identified overlapping resources for sensing and sidelink communication may perform interference cancellation. In such cases, each sensing transmission transmitted from any of a set of UEs may use the same waveform for sensing or may have waveforms selected from a finite set such that a corresponding UE may perform interference cancellation using such waveforms (e.g., using the inverse of these waveforms). In some examples, the waveform may be specified as a single-slot transmission and may be extended via repetition of this single-slot transmission.

Additionally, overlap may be limited between resources for sensing and resources for sidelink communications in at least some instances (e.g., instances in which interference is likely to be high). For instance, a first UE configured to transmit a sensing transmission may receive, from a second UE, an indication of first resources (e.g., via sidelink control information (SCI)) for transmitting a sidelink transmission. The first UE, when determining second resources for transmitting the sensing transmission may treat the first resources as available for inclusion in the second resources under one or more conditions (e.g., if a total set of monitored and non-reserved resources within a resource window is below a first threshold, if a corresponding reference signal received power (RSRP) satisfies a second threshold, or if a percentage of overlap between one or more of the first resources and the second resources satisfies a threshold) or may treat the first resources as available regardless of whether these conditions are satisfied. In some examples, the first UE may receive, from the second UE or a third UE, an indication of third resources (e.g., via SCI). The first UE may treat these resources as reserved (e.g., unavailable for inclusion in the second set of resources) or may include them based on one or more conditions (e.g., if these resources meet certain metrics, such as if an RSRP of the signal indicating the first resources satisfies a threshold or if the transmissions would overlap for below a threshold number of symbols or slots). After selecting the second resources, the first UE may transmit an indication of the second resources (e.g., via SCI). However, in other examples, the first UE may refrain from transmitting the indication of the second resources (e.g., via SCI).

In some examples, the second UE configured to transmit the sidelink transmission may receive, from another UE (e.g., the first UE, the third UE, or a fourth UE), an indication of resources for sensing. The second UE may treat these resources as available for inclusion in the first resources or may exclude them based on one or more conditions (e.g., based on a congestion level, a priority of a CV2X transmission, a packet data budget of the CV2X transmission, or an interference level).

Aspects of the disclosure are initially described in the context of wireless communications systems. Additional aspects of the disclosure are described in the context of a sidelink resource pool and process flows. Aspects of the disclosure are further illustrated by and described with reference to apparatus diagrams, system diagrams, and flowcharts that relate to low power superimposed sensing transmissions for efficient joint communication and sensing.

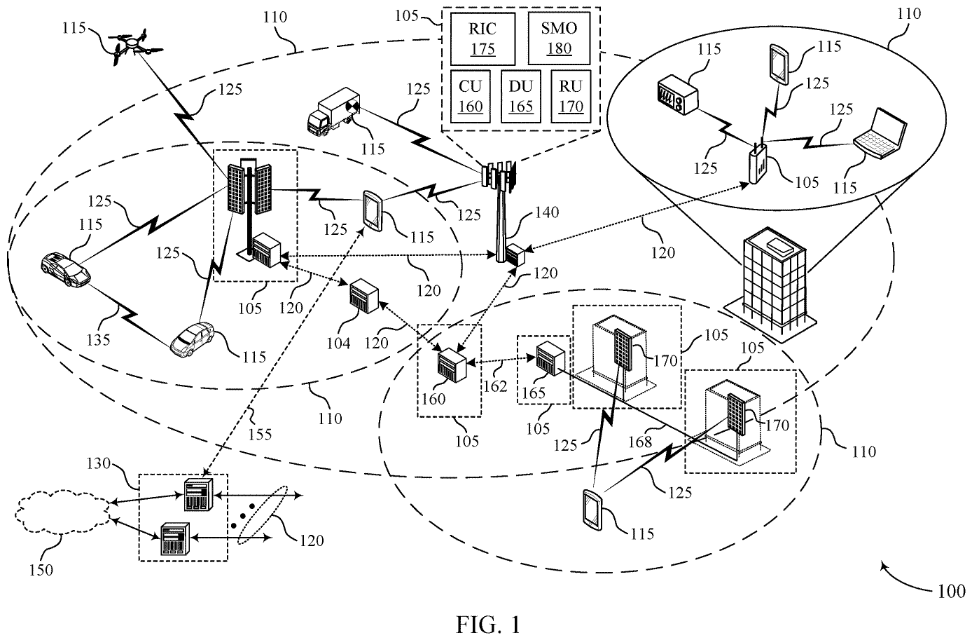

FIG. 1 illustrates an example of a wireless communications system 100 that supports low power superimposed sensing transmissions for efficient joint communication and sensing in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support low power superimposed sensing transmissions for efficient joint communication and sensing as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

UEs 115 communicating which each other may perform sidelink communication and may also perform sensing (e.g., radar sensing). If time-frequency resources for sensing overlap with time-frequency resources for performing sidelink communication (e.g., CV2X communication), a UE 115 that receives both a corresponding sensing transmission (e.g., a signal associated with sensing) and a corresponding sidelink transmission (e.g., a signal associated with sidelink communication) may fail to receive and decode the sidelink transmission. However, limiting resources for sensing and resources for sidelink transmissions in all cases may decrease the efficiency of wireless communications.

The methods described herein may enable overlap between resources for sensing and resources for sidelink communications while decreasing, on average, a likelihood that a UE fails to receive and decode a sidelink transmission due to one or more interfering sensing transmissions. For instance, the sensing transmission may be transmitted at a lower power and a longer duration (e.g., over more resources) as compared to the sidelink transmission. However, in some such examples, the interference may be high enough such that receiving both transmissions may result in the UE 115 still failing to receive the sidelink transmission. Accordingly, as described herein, a UE 115 that has identified overlapping resources for sensing and sidelink communication may perform interference cancellation. In such cases, each sensing transmission may have the same waveform or may have waveforms selected from a finite set such that the UE 115 may perform interference cancellation using such waveforms (e.g., using the inverse of these waveforms). In some examples, the waveform may be specified as a single-slot transmission and may be extended via repetition of this single-slot transmission.

Additionally, overlap may be limited between resources for sensing and resources for sidelink communications in at least some instances (e.g., instances in which interference is likely to be high). For instance, a first UE 115 configured to transmit a sensing transmission may receive, from a second UE 115, an indication of first resources (e.g., via SCI) for transmitting a sidelink transmission. The first UE 115, when determining second resources for transmitting the sensing transmission may treat the first resources as available for inclusion in the second resources under one or more conditions (e.g., if a total set of monitored and non-reserved resources within a resource window is below a first threshold, if a corresponding RSRP satisfies a second threshold, or if a percentage of overlap between one or more of the first resources and the second resources satisfies a threshold) or may treat the first resources as available in each case. In some examples, the first UE 115 may receive, from the second UE 115 or a third UE 115, an indication of third resources (e.g., via SCI). The first UE 115 may treat these resources as reserved (e.g., unavailable for inclusion in the second set of resources) or may include them based on one or more conditions (e.g., if these resources meet certain metrics, such as having an RSRP that satisfies a threshold or if the transmissions would overlap for below a threshold number of symbols or slots). After selecting the second resources, the first UE 115 may transmit an indication of the second resources (e.g., via SCI). However, in other examples, the first UE 115 may refrain from transmitting the indication of the second resources (e.g., via SCI).

In some examples, the second UE 115 configured to transmit the sidelink transmission may receive, from another UE 115 (e.g., the first UE 115, the third UE 115, or a fourth UE 115), an indication of resources for sensing. The second UE 115 may treat these resources as available for inclusion in the first resources or may exclude them based on one or more conditions (e.g., based on a congestion level, a priority of a CV2X transmission, a packet data budget of the CV2X transmission, or an interference level).

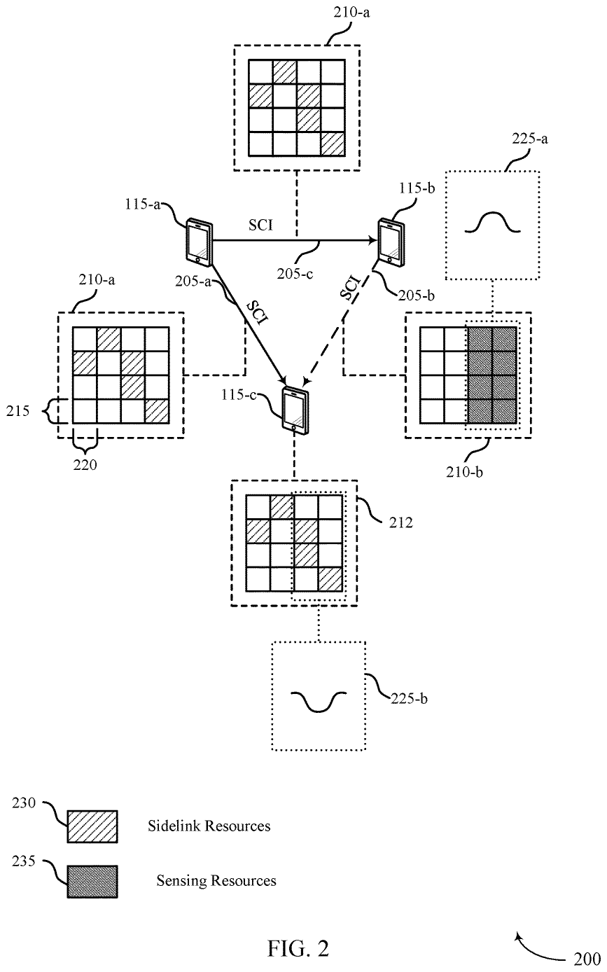

FIG. 2 illustrates an example of a wireless communications system 200 that supports low power superimposed sensing transmissions for efficient joint communication and sensing in accordance with one or more aspects of the present disclosure. In some examples, wireless communications system 200 may implement one or more aspects of wireless communications system 100. For instance, UEs 115-a, 115-b, and 115-c may each be examples of UEs 115 as described with reference to FIG. 1.

UEs 115-a, 115-b and 115-c may be capable of performing sidelink communications (e.g., transmitting CV2X transmissions, physical sidelink shared channel (PSSCH) transmissions, physical sidelink control channel (PSCCH) transmissions) and/or communicating sensing transmissions (e.g., radar). In some examples, such sensing transmissions may be accommodated by one or more layers of UEs 115-a, 115-b, 115-c (e.g., a physical (PHY) layer or a MAC layer), or any combination thereof as a type of traffic. Communications networks that utilize sensing transmissions may perform sensing as a service, in which communication devices may be capable of on-demand radio frequency (RF) sensing and/or sensing-assisted communications, in which sensing is performed transparently to a user to improve communication performance (e.g., such that the UE may identify or predict beams associated with greater accuracy or increased wireless communications efficiency). In one or both cases, sensing transmissions may be performed over the same time-frequency resources as other transmissions (e.g., sidelink transmissions), which may enable increased spectral efficiency and may enable mechanisms for coordinated channel access (e.g., mechanisms for avoiding collisions). To enable improved spectral efficiency or these mechanisms, sensing transmissions may be treated as a type of traffic supported by a communications network (e.g., by wireless communications system 100). Sensing transmissions and/or applications thereof may use the same waveforms and/or procedures as other transmissions and/or applications (e.g., sidelink transmissions and/or applications), and may accordingly be transparent to one or more layers of UEs 115-a, 115-b, and 115-c (e.g., the MAC layer and/or the PHY layer). In some examples, an OFDM waveform, may be used as a waveform for a sensing transmission.

The traffic load introduced by sensing transmissions may affect wireless communications among wireless devices (e.g., may create additional interference, increased overhead), as sensing transmissions may have a larger bandwidth, duration (e.g., a larger coherent processing interval (CPI)), and/or duty cycle as compared to other transmissions (e.g., sidelink transmissions, such as CV2X transmissions). For instance, for automotive applications, the sensing bandwidth may be greater than or equal to 100 Megahertz (MHz) and the CPI may be within the range of 10 to 20 milliseconds. The sensing cycle may have a value of 100 milliseconds or less. Because of the increased bandwidth, duration, and/or duty cycle associated with a sensing transmission, a larger number of slots, resource blocks (RBs), and/or subchannels are used by a wireless device (e.g., UEs 115-a, 115-b, 115-c) when the wireless device performs sensing transmissions (e.g., transmits sensing signals) as compared to other transmissions (e.g., sidelink transmissions such as CV2X transmissions). Accordingly, resource availability may be impacted when multiple wireless devices (e.g., multiple UEs) are sharing a spectrum, performing communications (e.g., sidelink communications) and/or performing sensing on transmissions. One method for decreasing the impact of sensing transmissions on wireless communication may be to use transmission resource patterns that include resource element (RE)-based and symbol-based interlaces, enabling multiplexing of sensing transmissions over a same bandwidth and a same CPI. However, such a method may include performing a discontinuous transmission of a sensing transmission over the time domain, which may lead to a loss of phase continuity among sensing symbols within a CPI. Accordingly, wireless devices using this scheme may result in a loss of a wireless device to determine a Doppler (e.g., velocity) estimation, which may impact wireless communications if the wireless device uses Doppler (e.g., velocity) estimation for performing communications). For instance, Doppler (e.g., estimation) may be important information for various applications (e.g., automotive applications), and failure to acquire an accurate Doppler estimation may decrease the efficiency of wireless communications.

For wireless devices (e.g., UEs) that intend to use Doppler (e.g., velocity) estimation, sensing transmissions may be contiguous and may span multiple symbols and/or slots (e.g., which may include a CPI). In examples in which multiple wireless devices that use Doppler estimation are active within a same area (e.g., in automotive applications), a total number of available resources may not support a total amount of traffic generated by sensing transmissions and other transmissions (e.g., sidelink transmissions). Such a scenario may occur during mode-2 sidelink operation, where a large amount of traffic volume over a single resource pool may be accommodated without network assistance.

The techniques described herein may describe a resource selection scheme and/or access scheme for mode-2 sidelink that may accommodate sidelink and sensing transmissions for wireless devices that use Doppler (e.g., velocity) estimation, where the sensing transmissions may span larger than one slot duration per transmission. In some examples, a sensing transmission may span multiple symbols and/or slots which may lead to a larger time integration gain than is achievable as compared to single symbol or slot transmissions. Accordingly, the sensing transmission power may be reduced to achieve a same integration gain over the multiple symbols and/or slots as compared to a transmission transmitted over a single symbol and/or slot. Additionally (e.g., because of the larger integration gain), sensing transmissions may be more robust to the presence of interfering signals active within their CPI. Due to this increased robustness, sensing transmissions may, in at least some cases, be performed in non-dedicated resources (e.g., the resources may be used for other transmissions, such as sidelink transmissions). For instance, sensing transmissions whose CPI exceeds a threshold (e.g., spans multiple symbols and/or slots) may be performed with a smaller transmission power as compared to sensing transmissions whose CPI don't exceed the threshold and may be performed over resources that other wireless devices may use for their own transmissions (e.g., sensing or sidelink transmissions) and/or that other UEs have previously reserved. In some examples, this threshold and the corresponding reduced transmission power may be configured or preconfigured at the wireless device.

In some examples, when a sidelink transmission (e.g., a non-sensing transmission) transmitted by a wireless device is performed over a same resource as a sensing transmission (e.g., transmitted by another wireless device), an amount of interference between the sidelink transmission and the sensing transmission may be below a threshold due to a reduced power of the sensing transmission. However, in some cases, the amount of interference may be above the threshold even with the sensing transmission being transmitted at the reduced power. Accordingly, a resource selection procedure may allow for a receiving wireless device that has identified that it will receive a sidelink transmission to cancel a sensing transmission that is transmitted over the same resources as the sensing transmission.

The methods described herein exploit an increased time-integration gain achievable by increased CPI sensing transmissions (e.g., sensing transmissions that span multiple slots and/or symbols) to reduce the transmission power and the corresponding interference between the sensing transmission and any other transmissions. Such reduction in interference may be achieved by updating resource selection and reservation procedures. In order to reduce (e.g., minimize) sensing transmissions being superimposed onto sidelink transmissions, an interference cancellation scheme may be implemented by updating a resource pool definition and one or more aspects of sensing waveforms.

In a first example, UE 115-b may receive, from UE 115-a, an SCI 205-a that includes a resource indication 210-a. SCI 205-a may indicate one or more sidelink resources 230 (e.g., resources for performing sidelink communications), where each of the one or more sidelink resources 230 may span a respective frequency region 215 (e.g., sub-channels, sub-bands) and a respective time region 220 (e.g., slots, symbols). UE 115-b, when determining sensing resources 235 (e.g., resources for communicating a sensing transmission) may identify a set of available resources (e.g., monitored and/or non-reserved resources) within a resource window. In some examples, UE 115-b may include at least one of the one or more sidelink resources 230 (e.g., indicated resources) in the set of available resources if the set of available resources is below a threshold size. UE 115-b may then randomly select resources from that set for transmitting a sensing transmission. In other examples, the set of available resources may include each resource within a resource window, irrespective of whether the resource is indicated for sensing, monitored, or non-reserved. In some such examples, UE 115-b may then randomly select from that set for transmitting the sensing transmission. Additionally or alternatively, the selection process may be biased such that UE 115-b may be more likely to select resources that have been reserved by other UEs received with a reference signal reserved power (RSRP) satisfying (e.g., exceeding) a threshold and/or a transmission duration of the reserved resources overlapping with a sensing duration by less than a threshold amount of slots and/or symbols. In some examples, biasing the resources may include associating a higher probability weight with resources that satisfy one or both of these conditions as compared to resources that do not satisfy one or both of these conditions. Additionally or alternatively, biasing the resources may include selecting only from non-reserved resources, monitored resources, and resources that satisfy one or both of these conditions. In some examples, the RSRP may refer to the transmission used to reserve the resources (e.g., SCI 205-c). Randomly selecting the resources may enable a more simple selection process to be implemented at UE 115-b (e.g., the complexity or latency of the selection process may be reduced). Biasing at least some of the resources may allow or increased resource reuse. For instance, in such examples, the sensing transmission power may be too small to prevent another transmission on another link from being successfully received and decoded. Additionally, the other link duration may be small enough such that its effect may be integrated out by a CPI for sensing that extends multiple symbols and/or slots.

In some examples, UE 115-b may receive, from UE 115-a or another UE, an SCI whose resource indication indicates one or more sensing resources (e.g., sensing-indicated resources). In some examples, collisions between sensing transmissions may not negatively impact wireless communications due to their reduced power and increased integration gain. Accordingly, UE 115-b may treat the one or more sensing resources as available resources when determining the set of available resources. However, there may be examples in which multiple sensing transmissions overlapping may negatively impact wireless communications. For instance, as a number of sensing transmissions that overlap increases, the corresponding amount of interference between the sensing transmissions and other transmissions may increase. Additionally, the total amount of interference may increase as the overlap between the two sensing transmissions increases, which may lead to no interference suppression by integration gain when selecting resources for sensing transmissions. To avoid interference in such examples, in a first option, UE 115-b may treat the one or more sensing resources as reserved (e.g., but may pre-empt or use these resources if no free resources are available based on priorities). Alternatively, in a second option, UE 115-b may treat the one or more sensing resources as available if they do not overlap with the sensing transmission for which UE 115-b is selecting resources for more than a threshold percentage of the resources of that transmission. In some examples, this threshold percentage may be configured or preconfigured at UE 115-b. Additionally or alternatively, in a third option, UE 115-b may treat the one or more sensing resources as available to select from, except for those whose reservation RSRP satisfies a threshold (e.g., a configured or preconfigured threshold). In some examples, whether the first option, the second option, the third option, or a combination thereof are applied may be configured (e.g., via signaling) or pre-configured at UE 115-b.

In some examples, UE 115-b may transmit an SCI 205-b that includes a resource indication 210-b, where the resource indication 210-b may indicate one or more sensing resources 235 (e.g., the sensing resources previously determined during resource selection). In some examples, each of the one or more sensing resources 235 may span a respective frequency region 215 (e.g., sub-bands, sub-channels) and a respective time region 220 (e.g., slots, symbols). It should be noted that there may be examples in which UE 115-b may refrain from explicitly transmitting the resource indication 210-b. However, providing the resource indication 210-b may enable other UEs (e.g., UE 115-c) to account for the one or more sensing resources 235 when performing resource selection and/or reservation. In some examples, the one or more sensing resources 235 may be indicated using a time resource indicator value (TRIV) field, a frequency resource indicator value (FRIV) field, or both. These fields may act as an indication of the one or more sensing resources 235 (e.g., as opposed to an explicit reservation). In some examples, SCI 205-b (e.g., an SCI-1) may include a field (e.g., a single-bit field) to indicate whether a TRIV or FRIV is to be interpreted as an indication of one or more sensing resources 235 or an explicit reservation (e.g., indicating the one or more sensing resources as explicitly reserved). If indicated as explicitly reserved, UE 115-c, in at least some examples, may explicitly exclude these resources from consideration when scheduling transmissions.

In some examples, when UE 115-a is selecting the one or more sidelink resources 230 (e.g., to be provided in SCIs 205-a and/or 205-c), UE 115-a may select the one or more sidelink resources 230 by identifying which resources are available within a resource window and then selecting (e.g., randomly) from them. If UE 115-a receives an indication of sensing resources (e.g., via SCI from another UE), UE 115-a may treat these resources as available. Alternatively, UE 115-a may treat them as reserved (e.g., and thus not available) based on one or more criteria. Such criteria may include congestion level satisfying a first threshold (e.g., as indicated by channel busy ratio (CBR) measurements); priority of the sidelink transmission to be transmitted over the one or more sidelink resources 230 satisfying a second threshold; a packet delay budget associated with the sidelink transmission to be transmitted over the one or more sidelink resources 230 satisfying a third threshold; an interference level (e.g., corresponding to an RSRP of the transmission that indicated the sensing resources, such as an SCI) satisfying a fourth threshold; or any combination thereof.

In some examples, the increased time-integration gain associated with sensing resources over which a sensing transmission is transmitted (e.g., at low power) may enable a receiving UE (e.g., UE 115-a) to receive a sidelink transmission whose sidelink resources overlap with the sensing transmission with reduced interference (e.g., the sensing transmission may be transmitted at a lower power than sidelink transmissions and thus cause less interference). However, a sidelink (e.g., CV2X) transmission may be impacted by the presence of a sensing transmission, even if the sensing transmission is received at a reduced power. To reduce this impact, the UE receiving the sidelink transmission may perform interference cancellation such that interference from the sensing transmission is mitigated (e.g., canceled) so that the sidelink transmission may be recovered as though no or a reduced amount of interference is present. To aid in the cancellation of the interference produced by the sensing transmission, the receiving UE may identify a presence of the sensing transmission or one or more properties thereof (e.g., a waveform) so that it may suppress (e.g., cancel) the sensing transmission from the received signal. Additionally, to aid in the cancellation, the receiving UE may identify whether or not a sensing transmission is present in a received signal.

To aid in a cancellation of interference from a sensing transmission, each sensing transmission (e.g., from UE 115-b) may have the exact same waveform or may have a waveform selected from a limited or finite set of allowed waveforms. Whether each of the sensing transmissions have the exact same waveform or have a waveform selected from the set may be configured (e.g., via signaling) or pre-configured and the set may be configured (e.g., via signaling) or pre-configured. Selecting the exact same waveform may be associated with reduced complexity for performing interference cancellation. However, selecting from the set may reduce the likelihood of ghost targets, which may form when using a common sensing waveform. In some examples, the sensing waveform may be specified or configured as a single-slot transmission. In some such examples, extended duration sensing transmissions may be achieved via repetition of the single slot configuration. Additionally or alternatively, the resource pool may include resource elements only used for sensing transmissions (e.g., sensing-reserved resource elements (REs)). A receiving UE (e.g., UE 115-a) may use these REs to detect the presence of a sensing transmission and to identify the channel experienced by the sensing transmission (if present) so as to be able to cancel it (e.g., using a sensing waveform). In some examples, the sensing-reserved REs may exclude sidelink (e.g., CV2X) demodulation reference signal (DMRS) REs. In some examples, the sensing-reserved REs may be configured (e.g., via signaling) or preconfigured. In some examples, sidelink (e.g., CV2X) transmissions may rate match around the sensing-reserved REs. Additionally or alternatively, the sensing-reserved REs may occur over symbols in a slot where no sidelink (e.g., CV2X) DMRS symbols are present.

In a first example, UE 115-c may receive SCI 205-a indicating resource indication 210-a from UE 115-a and may receive SCI 205-b indicating resource indication 210-b. Resource indication 210-a may provide an indication of one or more sidelink resources 230 and resource indication 210-b may provide an indication of one or more sensing resources 235. In some examples, the indicated one or more sensing resources 235 may overlap at least partially with the indicated one or more sidelink resources 230. For instance, at least one sensing resource of the one or more sensing resources 235 may span a same time region and frequency region as at least one sidelink resource of the one or more sidelink resources 230. In some examples, the sensing transmission associated with the one or more sensing resources 235 may have a waveform 225-a. UE 115-c may identify this waveform and may apply an inverse waveform 225-b to the signal received from UEs 115-a and 115-b in order to reduce or eliminate the interference from the sensing transmission. Accordingly, as shown in resource window 212, the sensing transmission may be reduced or eliminated and UE 115-c may receive the sidelink transmission over the portion overlapping with the one or more sensing resources 235.

In some examples, UE 115-c may perform the interference cancellation without first receiving SCI 205-a and/or SCI 205-b. For instance, UE 115-c may blindly attempt to decode sidelink transmissions without first receiving an SCI indicating resources for receiving sidelink transmissions. In such examples, UE 115-c may still perform interference cancellation according to the techniques described herein if UE 115-c receives a sidelink transmission.

In some examples, the techniques described herein may be applied to any signal whose power may be reduced as compared to another transmission (e.g., a sidelink transmission) and/or whose duration is longer as compared to the other transmission. For instance, long-duration (e.g., repeat) signals may be such a signal. Such signals may be treated similarly within resource selection, resource reservation, or other resource procedures. These signals may indicate their future resources and may tag these resources as to be used for sensing, for coverage extension, or for another purpose. Depending on the type of signal, differentiation in treatment may be present. For instance, when resource indications for future coverage-extension as well as sensing transmissions are available, a resource selection may favor treating only the sensing resources as available to select from (e.g., implicitly prioritizing and/or protecting the coverage-extension transmission).

In some examples, the techniques described herein may have one or more associated advantages. For instance, the techniques described herein may enable overlap between resources for sensing and resources for sidelink communications while decreasing, on average, a likelihood that a UE (e.g., UE 115-c) fails to receive a sidelink transmission due to one or more interfering sensing transmissions. Additionally, the techniques described herein may still enable a UE to perform Doppler velocity estimation, as the sensing transmission may be contiguous over multiple symbols and/or slots, which may enable the UE to perform more accurate wireless communications.

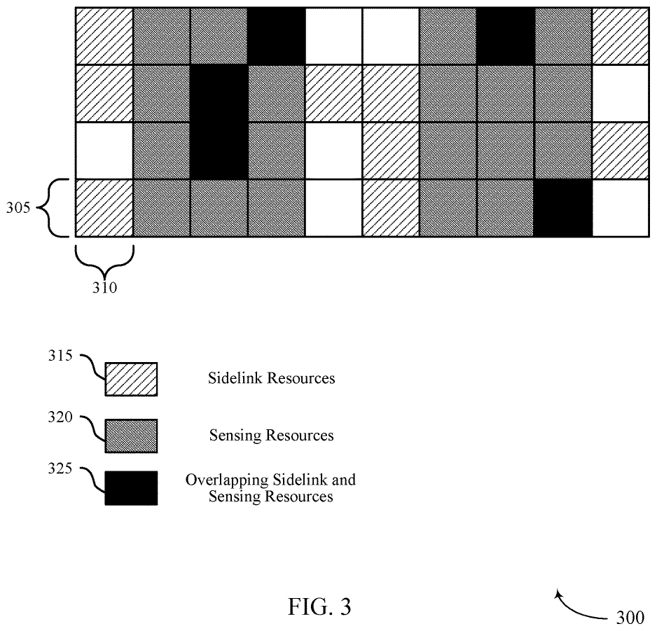

FIG. 3 illustrates an example of a sidelink resource pool 300 that supports low power superimposed sensing transmissions for efficient joint communication and sensing in accordance with one or more aspects of the present disclosure. In some examples, sidelink resource pool 300 may be implemented by one or more aspects of wireless communications system 200. For instance, frequency region 305 may an example of frequency region 215 as described with reference to FIG. 2; time region 310 may be an example of time region 220 as described with reference to FIG. 2; sidelink resources 315 may be an example of sidelink resources 230 as described with reference to FIG. 2; and sensing resources 320 may be an example of sensing resources 235 as described with reference to FIG. 2.

As depicted in FIG. 3, sensing resources 315 and sidelink resources 320 may overlap as overlapping resources 325. When this overlapping occurs, a UE (e.g., UE 115-c in FIG. 2) may perform interference cancellation to cancel out a sensing transmission transmitted on the sensing resources 315 and the overlapping resources 325. Performing the interference cancellation may enable the UE to receive each sidelink transmission over the overlapping resources 325 along with those on the sidelink resources 320.

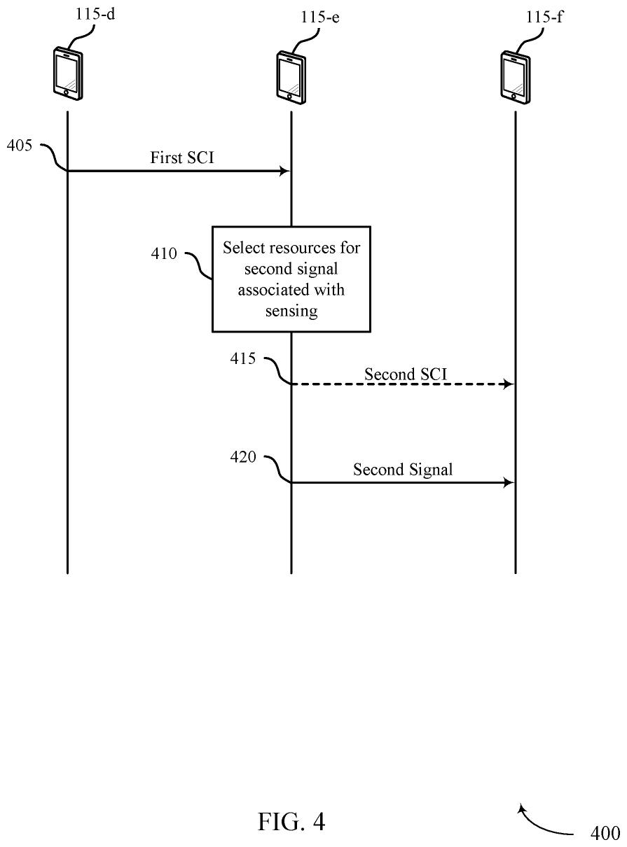

FIG. 4 illustrates an example of a process flow 400 that supports low power superimposed sensing transmissions for efficient joint communication and sensing in accordance with one or more aspects of the present disclosure. In some examples, process flow 400 may be implemented by one or more aspects of wireless communications systems 100 and/or 200. For instance, UE 115-d may be an example of a UE 115 as described with reference to FIG. 1 and/or UE 115-a as described with reference to FIG. 2; UE 115-e may be an example of a UE 115 as described with reference to FIG. 1 and/or UE 115-b as described with reference to FIG. 2; and UE 115-f may be an example of a UE 115 as described with reference to FIG. 1 and/or UE 115-c as described with reference to FIG. 2.

At 405, UE 115-d may transmit first SCI indicating that UE 115-d has selected a first set of time-frequency resources from a sidelink resource pool for transmitting a first signal associated with sidelink communication (e.g., a sidelink transmission). UE 115-e may receive the first SCI.

At 410, UE 115-e may select, for a second set of time-frequency resources, a first time-frequency resource of the first set of time-frequency resources. In some examples, UE 115-e may perform the selecting randomly. In some examples, the first time-frequency resource is selected for the second set of time-frequency resources based on a total number of monitored and non-reserved resources within a resource window associated with the sidelink resource pool being below a threshold. In some examples, the first time-frequency resource may be selected based on the first time-frequency resource being associated with an RSRP satisfying a threshold, a total duration of the first time-frequency resource overlapping with a total duration of the second set of time-frequency resources for less than a threshold amount of slots or symbols, or both. In some examples, the second set of time-frequency resources includes a time-frequency resource of the first set of time-frequency resources based on a duration associated with the second signal satisfying a first threshold, a power associated with the second signal satisfying a second threshold, or both. In some examples, selecting the second set of time-frequency resources is based on a metric associated with the first set of time-frequency resources (e.g., an RSRP of the first time-frequency resources, a total duration of the second set of time-frequency resources overlapping with a total duration of the second set of time-frequency resources for less than a threshold amount of slots or symbols, a total overlap between the first set of time-frequency resources and the second set of time-frequency resources being below a threshold percentage).

At 415, UE 115-e may transmit, subsequent to receiving the first SCI, second SCI indicating that UE 115-e has selected a second set of time-frequency resources from the sidelink resource pool for transmitting a second signal associated with sensing (e.g., a sensing transmission), where the second set of time-frequency resources at least partially overlap with the first set of time-frequency resources (e.g., the second set of time-frequency resources include the first time-frequency resource of the first set of time-frequency resources). In some examples, the second SCI may include a TRIV field, a FRIV field, or both indicating a time-frequency resource of the first set of time-frequency resources. The TRIV field, the FRIV field, or both includes an indication of whether the indicated time-frequency resource is reserved or available for a transmission distinct from the second signal associated with sensing.

At 420, UE 115-e may transmit, the second signal (e.g., a sensing transmission) using the second set of time-frequency resources and based on transmitting the second SCI. In some examples, UE 115-e may select a waveform for the second signal associated with sensing from a preconfigured set of waveforms based on selecting a time-frequency resource of the first set of time-frequency resources, where the second signal is transmitted with the selected waveform. In some examples, UE 115-e may generate a first waveform over multiple slots for the second signal associated with sensing by repeating a second waveform configured over a single slot and based on selecting a time-frequency resource of the first set of time-frequency resources, where the second signal is transmitted based on generating the first waveform.

In some examples, UE 115-e may receive third SCI indicating that UE 115-d or another UE has selected a third set of time-frequency resource from the sidelink resource pool for transmitting a third signal associated with sensing. In some such examples, UE 115 115-e may select, for a fourth set of time-frequency resources, a time-frequency resource of the third set of time-frequency resources. Alternatively, UE 115-e may select, for the fourth set of time-frequency resources, a time-frequency resource excluded from the third set of time-frequency resources based on a congestion level, a priority of a fourth signal associated with sidelink communication, packet delay budget of the fourth signal, an interference level associated with the third SCI, or any combination thereof. In either case, UE 115-e may transmit fourth SCI indicating that UE 115-e has selected the fourth set of time-frequency resources from the sidelink resource pool for transmitting the fourth signal associated with sidelink communication and transmitting the fourth signal using the fourth set of time-frequency resources. In some examples, the second set of time-frequency resources may exclude each resource of the third set of time-frequency resources based on receiving the third SCI. Additionally or alternatively, the second set of time-frequency resources may include a time-frequency resource of the third set of time-frequency resources based on less than a threshold percentage of the time-frequency resources of the third set of time-frequency resources overlapping with the time-frequency resources of the second set of time-frequency resources, the third set of time-frequency resources being associated with an RSRP below a threshold power.

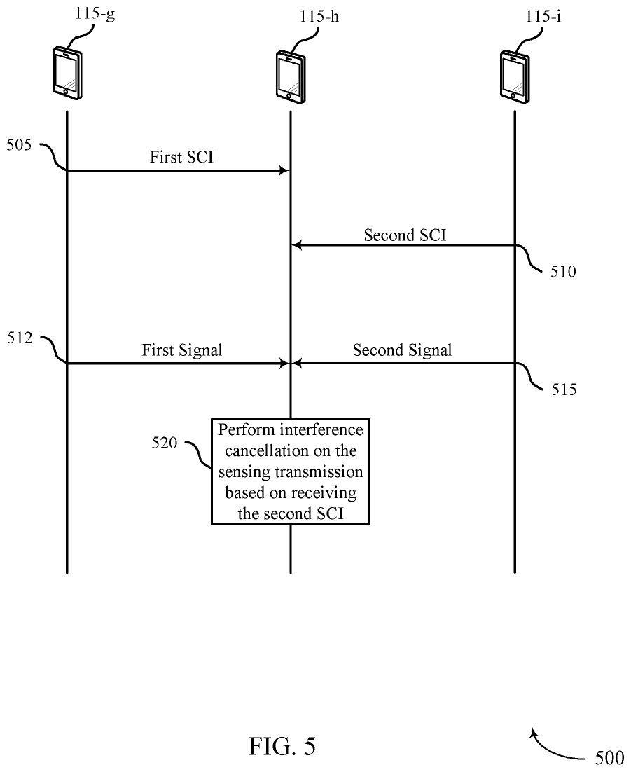

FIG. 5 illustrates an example of a process flow 500 that supports low power superimposed sensing transmissions for efficient joint communication and sensing in accordance with one or more aspects of the present disclosure. In some examples, process flow 500 may be implemented by one or more aspects of wireless communications systems 100 and/or 200. For instance, UE 115-g may be an example of a UE 115 as described with reference to FIG. 1 and/or UE 115-a as described with reference to FIG. 2; UE 115-h may be an example of a UE 115 as described with reference to FIG. 1 and/or UE 115-c as described with reference to FIG. 2; and UE 115-i may be an example of a UE 115 as described with reference to FIG. 1 and/or UE 115-b as described with reference to FIG. 2.

At 505, UE 115-g may transmit first SCI indicating that UE 115-g has selected a first time-frequency resource for transmitting a first signal associated with sidelink communication (e.g., a sidelink transmission). UE 115-h may receive the first SCI.

At 510, UE 115-i may transmit second SCI indicating that UE 115-i has selected at least the first time-frequency resource for transmitting a second signal associated with sensing (e.g., a sensing transmission). UE 115-h may receive the second SCI. In some examples, the second SCI may include a TRIV field, a FRIV field, or both indicating the first time-frequency resource. In some examples, the TRIV field, the FRIV field, or both may include an indication of whether the first time-frequency resource is reserved or available for a transmission distinct from the second signal associated with sensing.

At 512, UE 115-g may transmit the first signal associated with sidelink communication. At 515, UE 115-i may transmit the second signal associated with sensing.

At 520, UE 115-h may perform interference cancellation on the second signal associated with sensing to receive the first signal associated with sidelink communication over the first time-frequency resource based on receiving the second SCI indicating that UE 115-i has selected the first time-frequency resource. In some examples, UE 115-h may determine a waveform of the second signal associated with sensing from a preconfigured set of waveforms, where performing the interference cancellation is based on determining the waveform. In some examples, the waveform of the second signal may be configured for a single slot and repeated over multiple slots. In some such examples, UE 115-i may perform the interference cancellation based on the waveform of the second signal being configured for the single slot and repeated over multiple slots. In some examples, UE 115-i may receive an indication of a set of REs for detecting signals associated with sensing and may detect at least one signal associated with sensing over at least one of the set of REs, where performing the interference cancellation is based on the detecting. In some examples, the set of REs may exclude any RE configured for receiving one or more DMRSs of one or more transmissions unassociated with sensing. In some examples, UE 115-h may perform the interference cancellation without first receiving the first SCI (e.g., at 505) and/or the second SCI (e.g., at 510). For instance, UE 115-hmay blindly attempt to decode sidelink transmissions. In such examples, UE 115-h may still perform interference cancellation according to the techniques described herein.

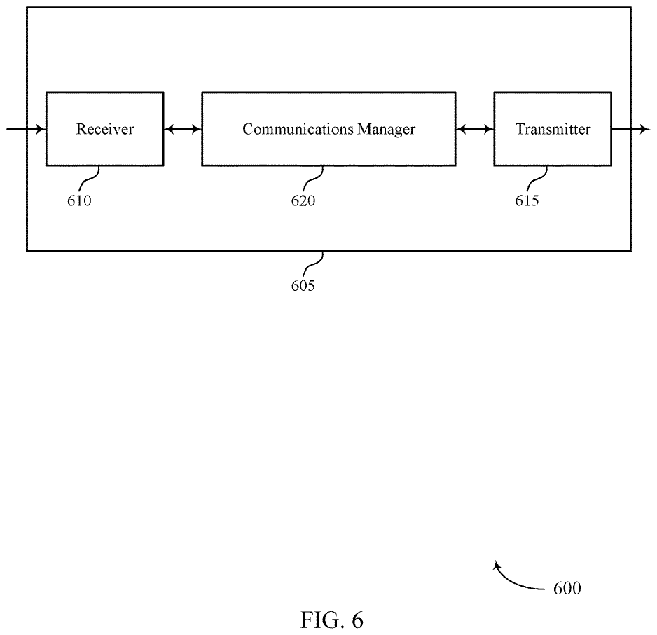

FIG. 6 illustrates a block diagram 600 of a device 605 that supports low power superimposed sensing transmissions for efficient joint communication and sensing in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to low power superimposed sensing transmissions for efficient joint communication and sensing). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to low power superimposed sensing transmissions for efficient joint communication and sensing). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of low power superimposed sensing transmissions for efficient joint communication and sensing as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first UE in accordance with examples as disclosed herein. For example, the communications manager 620 may be configured as or otherwise support a means for receiving first sidelink control information indicating that a second UE has selected a first set of time-frequency resources from a sidelink resource pool for transmitting a first signal associated with sidelink communication. The communications manager 620 may be configured as or otherwise support a means for transmitting, subsequent to receiving the first sidelink control information, second sidelink control information indicating that the first UE has selected a second set of time-frequency resources from the sidelink resource pool for transmitting a second signal associated with sensing, where the second set of time-frequency resources at least partially overlap with the first set of time-frequency resources. The communications manager 620 may be configured as or otherwise support a means for transmitting the second signal using the second set of time-frequency resources based on transmitting the second sidelink control information.

Additionally, or alternatively, the communications manager 620 may support wireless communication at a first UE in accordance with examples as disclosed herein. For example, the communications manager 620 may be configured as or otherwise support a means for receiving first sidelink control information indicating that a second UE has selected a first set of time-frequency resources from a sidelink resource pool for transmitting a first signal associated with sidelink communication. The communications manager 620 may be configured as or otherwise support a means for transmitting, subsequent to receiving the first sidelink control information, a second signal associated with sensing using a second set of time-frequency resources of the sidelink resource pool, where the second set of time-frequency resources at least partially overlap with the first set of time-frequency resources, and where selecting the second set of time-frequency resources is based on a metric associated with the first set of time-frequency resources.

Additionally, or alternatively, the communications manager 620 may support wireless communication at a first UE in accordance with examples as disclosed herein. For example, the communications manager 620 may be configured as or otherwise support a means for receiving first sidelink control information indicating that a second UE has selected a first time-frequency resource for transmitting a first signal associated with sidelink communication. The communications manager 620 may be configured as or otherwise support a means for receiving second sidelink control information indicating that a third UE has selected at least the first time-frequency resource for transmitting a second signal associated with sensing. The communications manager 620 may be configured as or otherwise support a means for performing interference cancellation on the second signal associated with sensing to receive the first signal associated with sidelink communication over the first time-frequency resource based on receiving the second sidelink control information indicating that the third UE has selected the first time-frequency resource.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for signals associated with sidelink communication and signals associated with sensing to overlap in at least some cases while limiting interference between them.

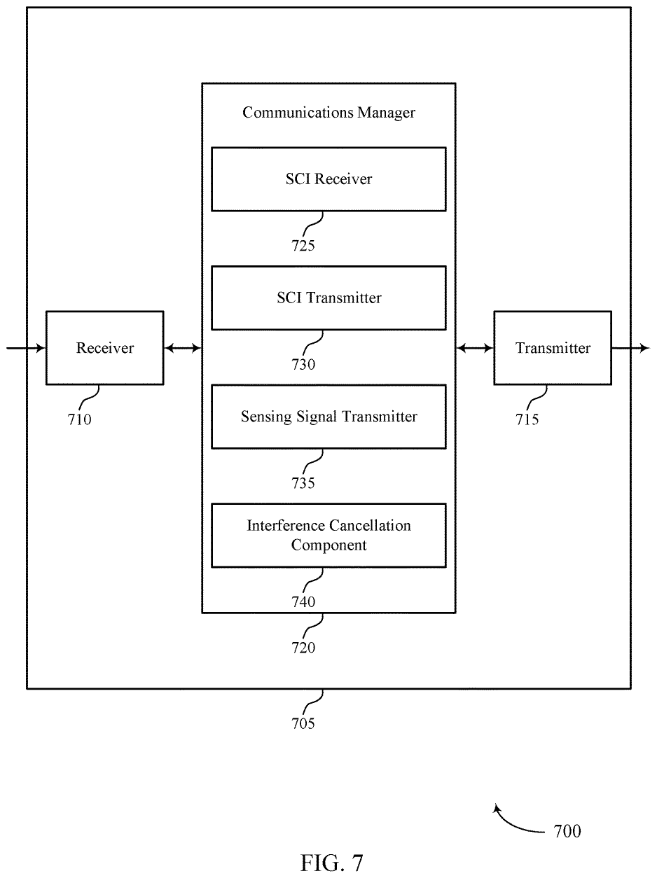

FIG. 7 illustrates a block diagram 700 of a device 705 that supports low power superimposed sensing transmissions for efficient joint communication and sensing in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to low power superimposed sensing transmissions for efficient joint communication and sensing). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to low power superimposed sensing transmissions for efficient joint communication and sensing). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of low power superimposed sensing transmissions for efficient joint communication and sensing as described herein. For example, the communications manager 720 may include an SCI receiver 725, an SCI transmitter 730, a sensing signal transmitter 735, an interference cancellation component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. The SCI receiver 725 may be configured as or otherwise support a means for receiving first sidelink control information indicating that a second UE has selected a first set of time-frequency resources from a sidelink resource pool for transmitting a first signal associated with sidelink communication. The SCI transmitter 730 may be configured as or otherwise support a means for transmitting, subsequent to receiving the first sidelink control information, second sidelink control information indicating that the first UE has selected a second set of time-frequency resources from the sidelink resource pool for transmitting a second signal associated with sensing, where the second set of time-frequency resources at least partially overlap with the first set of time-frequency resources. The sensing signal transmitter 735 may be configured as or otherwise support a means for transmitting the second signal using the second set of time-frequency resources based on transmitting the second sidelink control information.

Additionally, or alternatively, the communications manager 720 may support wireless communication at a first UE in accordance with examples as disclosed herein. The SCI receiver 725 may be configured as or otherwise support a means for receiving first sidelink control information indicating that a second UE has selected a first set of time-frequency resources from a sidelink resource pool for transmitting a first signal associated with sidelink communication. The SCI transmitter 730 may be configured as or otherwise support a means for transmitting, subsequent to receiving the first sidelink control information, a second signal associated with sensing using a second set of time-frequency resources of the sidelink resource pool, where the second set of time-frequency resources at least partially overlap with the first set of time-frequency resources, and where selecting the second set of time-frequency resources is based on a metric associated with the first set of time-frequency resources.

Additionally, or alternatively, the communications manager 720 may support wireless communication at a first UE in accordance with examples as disclosed herein. The SCI receiver 725 may be configured as or otherwise support a means for receiving first sidelink control information indicating that a second UE has selected a first time-frequency resource for transmitting a first signal associated with sidelink communication. The SCI receiver 725 may be configured as or otherwise support a means for receiving second sidelink control information indicating that a third UE has selected at least the first time-frequency resource for transmitting a second signal associated with sensing. The interference cancellation component 740 may be configured as or otherwise support a means for performing interference cancellation on the second signal associated with sensing to receive the first signal associated with sidelink communication over the first time-frequency resource based on receiving the second sidelink control information indicating that the third UE has selected the first time-frequency resource.

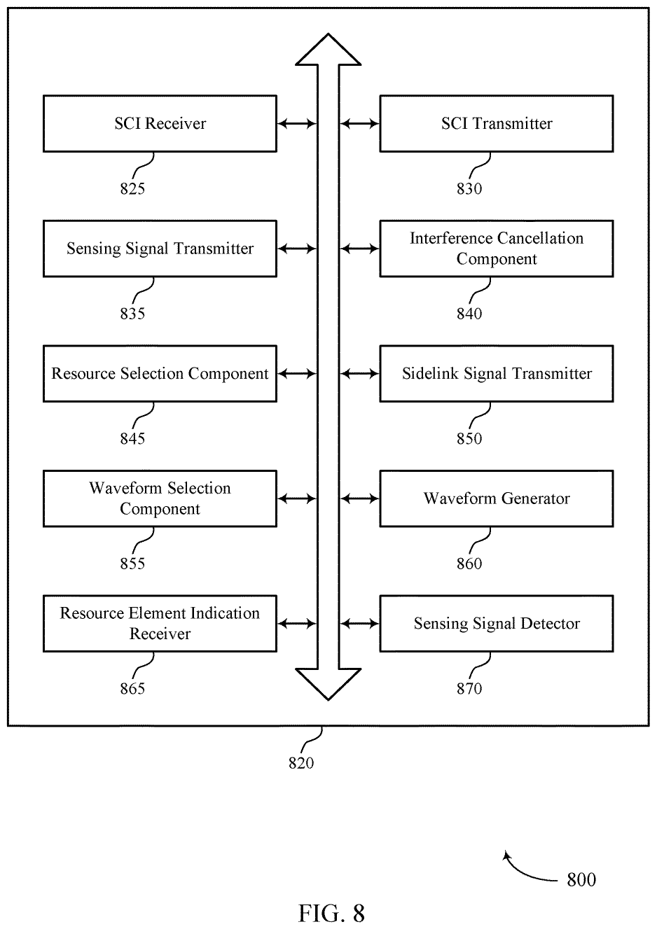

FIG. 8 illustrates a block diagram 800 of a communications manager 820 that supports low power superimposed sensing transmissions for efficient joint communication and sensing in accordance with one or more aspects of the present disclosure. The communications manager 820 may be an example of aspects of a communications manager 620, a communications manager 720, or both, as described herein. The communications manager 820, or various components thereof, may be an example of means for performing various aspects of low power superimposed sensing transmissions for efficient joint communication and sensing as described herein. For example, the communications manager 820 may include an SCI receiver 825, an SCI transmitter 830, a sensing signal transmitter 835, an interference cancellation component 840, a resource selection component 845, a sidelink signal transmitter 850, a waveform selection component 855, a waveform generator 860, a resource element indication receiver 865, a sensing signal detector 870, or any combination thereof. Each of these components may communicate, directly or indirectly, with one another (e.g., via one or more buses).

The communications manager 820 may support wireless communication at a first UE in accordance with examples as disclosed herein. The SCI receiver 825 may be configured as or otherwise support a means for receiving first sidelink control information indicating that a second UE has selected a first set of time-frequency resources from a sidelink resource pool for transmitting a first signal associated with sidelink communication. The SCI transmitter 830 may be configured as or otherwise support a means for transmitting, subsequent to receiving the first sidelink control information, second sidelink control information indicating that the first UE has selected a second set of time-frequency resources from the sidelink resource pool for transmitting a second signal associated with sensing, where the second set of time-frequency resources at least partially overlap with the first set of time-frequency resources. The sensing signal transmitter 835 may be configured as or otherwise support a means for transmitting the second signal using the second set of time-frequency resources based on transmitting the second sidelink control information.

In some examples, the resource selection component 845 may be configured as or otherwise support a means for randomly selecting, for the second set of time-frequency resources, a first time-frequency resource of the first set of time-frequency resources.

In some examples, the first time-frequency resource is selected for the second set of time-frequency resources based on a total number of monitored and non-reserved resources within a resource window associated with the sidelink resource pool being below a threshold.

In some examples, the resource selection component 845 may be configured as or otherwise support a means for selecting, for the second set of time-frequency resources, a first time-frequency resource of the first set of time-frequency resources based on the first time-frequency resource being associated with a reference signal received power above a threshold power, a total duration of the first time-frequency resource overlapping with a total duration of the second set of time-frequency resources for less than a threshold amount of slots or symbols, or both.

In some examples, the SCI receiver 825 may be configured as or otherwise support a means for receiving third sidelink control information indicating that the second UE or a third UE has selected a third set of time-frequency resources from the sidelink resource pool for transmitting a third signal associated with sensing. In some examples, the resource selection component 845 may be configured as or otherwise support a means for selecting, for a fourth set of time-frequency resources, a second time-frequency resource of the third set of time-frequency resources. In some examples, the SCI transmitter 830 may be configured as or otherwise support a means for transmitting fourth sidelink control information indicating that the first UE has selected the fourth set of time-frequency resources from the sidelink resource pool for transmitting a fourth signal associated with sidelink communication. In some examples, the sidelink signal transmitter 850 may be configured as or otherwise support a means for transmitting the fourth signal using the fourth set of time-frequency resources.

In some examples, the SCI receiver 825 may be configured as or otherwise support a means for receiving third sidelink control information indicating that the second UE or a third UE has selected a third set of time-frequency resources from the sidelink resource pool for transmitting a third signal associated with sensing. In some examples, the resource selection component 845 may be configured as or otherwise support a means for selecting, for a fourth set of time-frequency resources, a second time-frequency resource excluded from the third set of time-frequency resources based on a congestion level, a priority of a fourth signal associated with sidelink communication, packet delay budget of the fourth signal, an interference level associated with the third sidelink control information, or any combination thereof. In some examples, the SCI transmitter 830 may be configured as or otherwise support a means for transmitting fourth sidelink control information indicating that the first UE has selected the fourth set of time-frequency resources from the sidelink resource pool for transmitting the fourth signal associated with sidelink communication. In some examples, the sidelink signal transmitter 850 may be configured as or otherwise support a means for transmitting the fourth signal using the fourth set of time-frequency resources.

In some examples, the SCI receiver 825 may be configured as or otherwise support a means for receiving third sidelink control information indicating that that a third UE has selected a third set of time-frequency resources for transmitting a third signal associated with sensing, the second set of time-frequency resources excluding each resource of the third set of time-frequency resources based on receiving the third sidelink control information.

In some examples, the SCI receiver 825 may be configured as or otherwise support a means for receiving third sidelink control information indicating that a third UE has selected a third set of time-frequency resources for transmitting a third signal associated with sensing, the second set of time-frequency resources including a first time-frequency resource of the third set of time-frequency resources based on less than a threshold percentage of the time-frequency resources of the third set of time-frequency resources overlapping with the time-frequency resources of the second set of time-frequency resources, the third set of time-frequency resources being associated with a reference signal received power below a threshold power, or both.

In some examples, the waveform selection component 855 may be configured as or otherwise support a means for selecting a waveform for the second signal associated with the sensing from a preconfigured set of waveforms based on selecting a first time-frequency resource of the first set of time-frequency resources, where the second signal is transmitted with the selected waveform.

In some examples, the waveform generator 860 may be configured as or otherwise support a means for generating a first waveform over multiple slots for the second signal associated with sensing by repeating a second waveform configured over a single slot and based on selecting a first time-frequency resource of the first set of time-frequency resources, where the second signal is transmitted based on generating the first waveform.

In some examples, the second sidelink control information includes a time resource indication value field, a frequency resource indication value field, or both indicating a first time-frequency resource of the first set of time-frequency resources.

In some examples, the time resource indication value field, the frequency resource indication value field, or both includes an indication of whether the first time-frequency resource is reserved or available for a transmission distinct from the second signal associated with sensing.

In some examples, the second set of time-frequency resources includes a first time-frequency resource of the first set of time-frequency resources based on a duration associated with the second signal satisfying a first threshold, a power associated with the second signal satisfying a second threshold, or both.

Additionally, or alternatively, the communications manager 820 may support wireless communication at a first UE in accordance with examples as disclosed herein. In some examples, the SCI receiver 825 may be configured as or otherwise support a means for receiving first sidelink control information indicating that a second UE has selected a first set of time-frequency resources from a sidelink resource pool for transmitting a first signal associated with sidelink communication. In some examples, the SCI transmitter 830 may be configured as or otherwise support a means for transmitting, subsequent to receiving the first sidelink control information, a second signal associated with sensing using a second set of time-frequency resources of the sidelink resource pool, where the second set of time-frequency resources at least partially overlap with the first set of time-frequency resources, and where selecting the second set of time-frequency resources is based on a metric associated with the first set of time-frequency resources.

In some examples, the resource selection component 845 may be configured as or otherwise support a means for randomly selecting, for the second set of time-frequency resources, a first time-frequency resource of the first set of time-frequency resources.

In some examples, the first time-frequency resource is selected for the second set of time-frequency resources based on a total number of monitored and non-reserved resources within a resource window associated with the sidelink resource pool being below a threshold.

In some examples, the resource selection component 845 may be configured as or otherwise support a means for selecting, for the second set of time-frequency resources, a first time-frequency resource of the first set of time-frequency resources based on the first time-frequency resource being associated with a reference signal received power above a threshold power, a total duration of the first set of time-frequency resources overlapping with a total duration of the second set of time-frequency resources for less than a threshold amount of slots or symbols, or both.

Additionally, or alternatively, the communications manager 820 may support wireless communication at a first UE in accordance with examples as disclosed herein. In some examples, the SCI receiver 825 may be configured as or otherwise support a means for receiving first sidelink control information indicating that a second UE has selected a first time-frequency resource for transmitting a first signal associated with sidelink communication. In some examples, the SCI receiver 825 may be configured as or otherwise support a means for receiving second sidelink control information indicating that a third UE has selected at least the first time-frequency resource for transmitting a second signal associated with sensing. The interference cancellation component 840 may be configured as or otherwise support a means for performing interference cancellation on the second signal associated with sensing to receive the first signal associated with sidelink communication over the first time-frequency resource based on receiving the second sidelink control information indicating that the third UE has selected the first time-frequency resource.

In some examples, the waveform selection component 855 may be configured as or otherwise support a means for determining a waveform of the second signal associated with sensing from a preconfigured set of waveforms, where performing the interference cancellation is based on determining the waveform.

In some examples, a waveform of the second signal is configured for a single slot and repeated over multiple slots. In some examples, performing the interference cancellation is based on the waveform of the second signal being configured for the single slot and repeated over the multiple slots.

In some examples, the resource element indication receiver 865 may be configured as or otherwise support a means for receiving an indication of a set of resources elements for detecting signals associated with sensing. In some examples, the sensing signal detector 870 may be configured as or otherwise support a means for detecting at least one signal associated with sensing over at least one of the set of resource elements, where performing the interference cancellation is based on detecting the at least one signal associated with sensing over the at least one of the set of resource elements.

In some examples, the set of resource elements excludes any resource elements configured for receiving one or more demodulation reference signals of one or more transmissions unassociated with sensing.

In some examples, the second sidelink control information includes a time resource indication value field, a frequency resource indication value field, or both indicating the first time-frequency resource.

In some examples, the time resource indication value field, the frequency resource indication value field, or both includes an indication of whether the first time-frequency resource is reserved or available for a transmission distinct from the second signal associated with sensing.

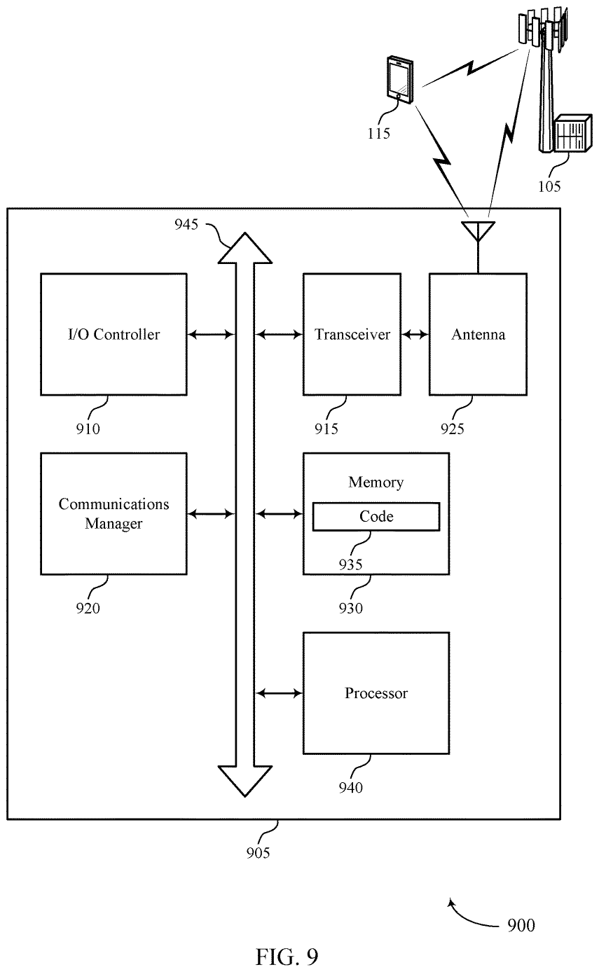

FIG. 9 illustrates a diagram of a system 900 including a device 905 that supports low power superimposed sensing transmissions for efficient joint communication and sensing in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting low power superimposed sensing transmissions for efficient joint communication and sensing). For example, the device 905 or a component of the device 905 may include a processor 940 and memory 930 coupled with or to the processor 940, the processor 940 and memory 930 configured to perform various functions described herein.

The communications manager 920 may support wireless communication at a first UE in accordance with examples as disclosed herein. For example, the communications manager 920 may be configured as or otherwise support a means for receiving first sidelink control information indicating that a second UE has selected a first set of time-frequency resources from a sidelink resource pool for transmitting a first signal associated with sidelink communication. The communications manager 920 may be configured as or otherwise support a means for transmitting, subsequent to receiving the first sidelink control information, second sidelink control information indicating that the first UE has selected a second set of time-frequency resources from the sidelink resource pool for transmitting a second signal associated with sensing, where the second set of time-frequency resources at least partially overlap with the first set of time-frequency resources. The communications manager 920 may be configured as or otherwise support a means for transmitting the second signal using the second set of time-frequency resources based on transmitting the second sidelink control information.

Additionally, or alternatively, the communications manager 920 may support wireless communication at a first UE in accordance with examples as disclosed herein. For example, the communications manager 920 may be configured as or otherwise support a means for receiving first sidelink control information indicating that a second UE has selected a first set of time-frequency resources from a sidelink resource pool for transmitting a first signal associated with sidelink communication. The communications manager 920 may be configured as or otherwise support a means for transmitting, subsequent to receiving the first sidelink control information, a second signal associated with sensing using a second set of time-frequency resources of the sidelink resource pool, where the second set of time-frequency resources at least partially overlap with the first set of time-frequency resources, and where selecting the second set of time-frequency resources is based on a metric associated with the first set of time-frequency resources.

Additionally, or alternatively, the communications manager 920 may support wireless communication at a first UE in accordance with examples as disclosed herein. For example, the communications manager 920 may be configured as or otherwise support a means for receiving first sidelink control information indicating that a second UE has selected a first time-frequency resource for transmitting a first signal associated with sidelink communication. The communications manager 920 may be configured as or otherwise support a means for receiving second sidelink control information indicating that a third UE has selected at least the first time-frequency resource for transmitting a second signal associated with sensing. The communications manager 920 may be configured as or otherwise support a means for performing interference cancellation on the second signal associated with sensing to receive the first signal associated with sidelink communication over the first time-frequency resource based on receiving the second sidelink control information indicating that the third UE has selected the first time-frequency resource.

By including or configuring the communications manager 920 in accordance with examples as described herein, the device 905 may support techniques for signals associated with sidelink communication and signals associated with sensing to overlap in at least some cases while limiting interference between them.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of low power superimposed sensing transmissions for efficient joint communication and sensing as described herein, or the processor 940 and the memory 930 may be otherwise configured to perform or support such operations.

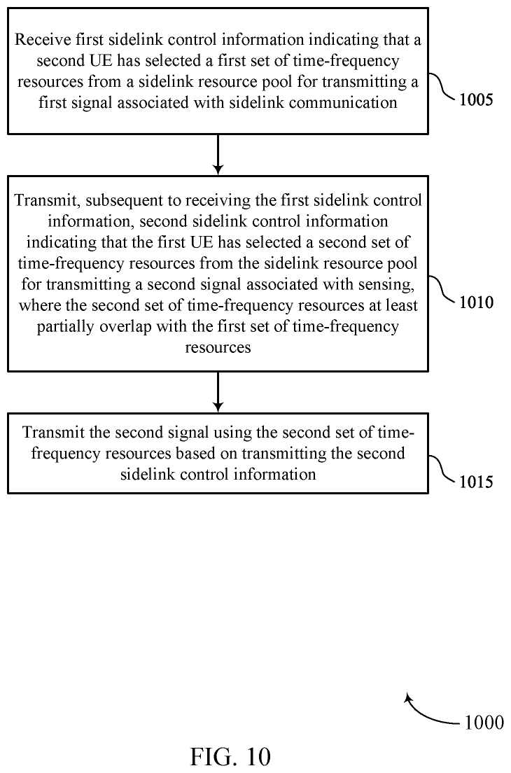

FIG. 10 illustrates a flowchart illustrating a method 1000 that supports low power superimposed sensing transmissions for efficient joint communication and sensing in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving first sidelink control information indicating that a second UE has selected a first set of time-frequency resources from a sidelink resource pool for transmitting a first signal associated with sidelink communication. The operations of 1005 may be performed in accordance with examples as disclosed herein. In some examples, aspects of the operations of 1005 may be performed by an SCI receiver 825 as described with reference to FIG. 8.

At 1010, the method may include transmitting, subsequent to receiving the first sidelink control information, second sidelink control information indicating that the first UE has selected a second set of time-frequency resources from the sidelink resource pool for transmitting a second signal associated with sensing, where the second set of time-frequency resources at least partially overlap with the first set of time-frequency resources. The operations of 1010 may be performed in accordance with examples as disclosed herein. In some examples, aspects of the operations of 1010 may be performed by an SCI transmitter 830 as described with reference to FIG. 8.

At 1015, the method may include transmitting the second signal using the second set of time-frequency resources based on transmitting the second sidelink control information. The operations of 1015 may be performed in accordance with examples as disclosed herein. In some examples, aspects of the operations of 1015 may be performed by a sensing signal transmitter 835 as described with reference to FIG. 8.

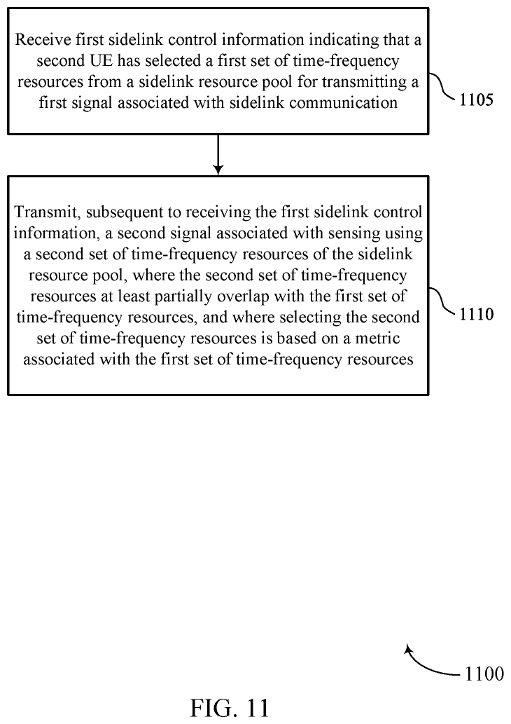

FIG. 11 illustrates a flowchart illustrating a method 1100 that supports low power superimposed sensing transmissions for efficient joint communication and sensing in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving first sidelink control information indicating that a second UE has selected a first set of time-frequency resources from a sidelink resource pool for transmitting a first signal associated with sidelink communication. The operations of 1105 may be performed in accordance with examples as disclosed herein. In some examples, aspects of the operations of 1105 may be performed by an SCI receiver 825 as described with reference to FIG. 8.

At 1110, the method may include transmitting, subsequent to receiving the first sidelink control information, a second signal associated with sensing using a second set of time-frequency resources of the sidelink resource pool, where the second set of time-frequency resources at least partially overlap with the first set of time-frequency resources, and where selecting the second set of time-frequency resources is based on a metric associated with the first set of time-frequency resources. The operations of 1110 may be performed in accordance with examples as disclosed herein. In some examples, aspects of the operations of 1110 may be performed by an SCI transmitter 830 as described with reference to FIG. 8.

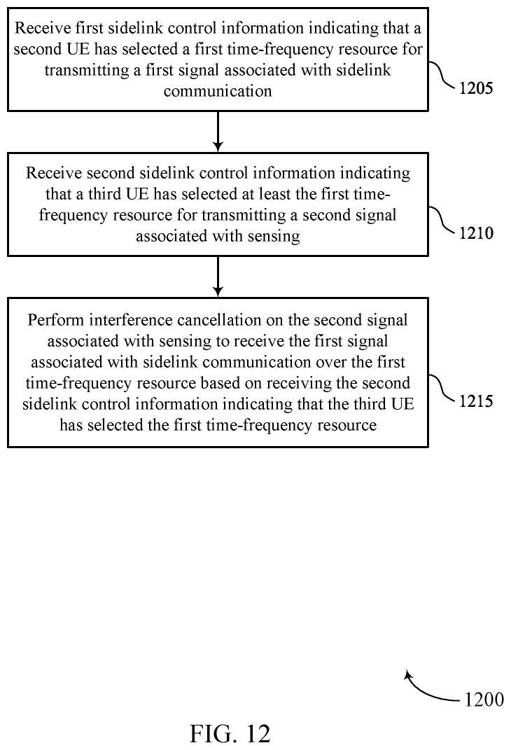

FIG. 12 illustrates a flowchart illustrating a method 1200 that supports low power superimposed sensing transmissions for efficient joint communication and sensing in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving first sidelink control information indicating that a second UE has selected a first time-frequency resource for transmitting a first signal associated with sidelink communication. The operations of 1205 may be performed in accordance with examples as disclosed herein. In some examples, aspects of the operations of 1205 may be performed by an SCI receiver 825 as described with reference to FIG. 8.

At 1210, the method may include receiving second sidelink control information indicating that a third UE has selected at least the first time-frequency resource for transmitting a second signal associated with sensing. The operations of 1210 may be performed in accordance with examples as disclosed herein. In some examples, aspects of the operations of 1210 may be performed by an SCI receiver 825 as described with reference to FIG. 8.

At 1215, the method may include performing interference cancellation on the second signal associated with sensing to receive the first signal associated with sidelink communication over the first time-frequency resource based on receiving the second sidelink control information indicating that the third UE has selected the first time-frequency resource. The operations of 1215 may be performed in accordance with examples as disclosed herein. In some examples, aspects of the operations of 1215 may be performed by an interference cancellation component 840 as described with reference to FIG. 8.

The following provides an overview of aspects of the present disclosure:
Aspect 1: A method for wireless communication at a first UE, comprising: receiving first sidelink control information indicating that a second UE has selected a first set of time-frequency resources from a sidelink resource pool for transmitting a first signal associated with sidelink communication; transmitting, subsequent to receiving the first sidelink control information, second sidelink control information indicating that the first UE has selected a second set of time-frequency resources from the sidelink resource pool for transmitting a second signal associated with sensing, wherein the second set of time-frequency resources at least partially overlap with the first set of time-frequency resources; and transmitting the second signal using the second set of time-frequency resources based at least in part on transmitting the second sidelink control information.
Aspect 2: The method of aspect 1, further comprising: randomly selecting, for the second set of time-frequency resources, a first time-frequency resource of the first set of time-frequency resources.
Aspect 3: The method of aspect 2, wherein the first time-frequency resource is selected for the second set of time-frequency resources based at least in part on a total number of monitored and non-reserved resources within a resource window associated with the sidelink resource pool being below a threshold.
Aspect 4: The method of any of aspects 1 through 3, further comprising: selecting, for the second set of time-frequency resources, a first time-frequency resource of the first set of time-frequency resources based at least in part on the first time-frequency resource being associated with a reference signal received power above a threshold power, a total duration of the first time-frequency resource overlapping with a total duration of the second set of time-frequency resources for less than a threshold amount of slots or symbols, or both.
Aspect 5: The method of any of aspects 1 through 4, further comprising: receiving third sidelink control information indicating that the second UE or a third UE has selected a third set of time-frequency resources from the sidelink resource pool for transmitting a third signal associated with sensing; selecting, for a fourth set of time-frequency resources, a second time-frequency resource of the third set of time-frequency resources; transmitting fourth sidelink control information indicating that the first UE has selected the fourth set of time-frequency resources from the sidelink resource pool for transmitting a fourth signal associated with sidelink communication; and transmitting the fourth signal using the fourth set of time-frequency resources.
Aspect 6: The method of any of aspects 1 through 5, further comprising: receiving third sidelink control information indicating that the second UE or a third UE has selected a third set of time-frequency resources from the sidelink pool for transmitting a third signal associated with sensing; selecting, for a fourth set of time-frequency resources, a second time-frequency resource excluded from the third set of time-frequency resources based at least in part on a congestion level, a priority of a fourth signal associated with sidelink communication, packet delay budget of the fourth signal, an interference level associated with the third sidelink control information, or any combination thereof; transmitting fourth sidelink control information indicating that the first UE has selected the fourth set of time-frequency resources from the sidelink resource pool for transmitting a fourth signal associated with sidelink communication; and transmitting the fourth signal using the fourth set of time-frequency resources.
Aspect 7: The method of any of aspects 1 through 6, further comprising: receiving third sidelink control information indicating that that a third UE has selected a third set of time-frequency resources for transmitting a third signal associated with sensing, the second set of time-frequency resources excluding each resource of the third set of time-frequency resources based at least in part on receiving the third sidelink control information.
Aspect 8: The method of any of aspects 1 through 7, further comprising: receiving third sidelink control information indicating that a third UE has selected a third set of time-frequency resources for transmitting a third signal associated with sensing, the second set of time-frequency resources comprising a first time-frequency resource of the third set of time-frequency resources based at least in part on less than a threshold percentage of the time-frequency resources of the third set of time-frequency resources overlapping with the time-frequency resources of the second set of time-frequency resources, the third set of time-frequency resources being associated with a reference signal received power below a threshold power, or both.
Aspect 9: The method of any of aspects 1 through 8, further comprising: selecting a waveform for the second signal associated with the sensing from a preconfigured set of waveforms based at least in part on selecting a first time-frequency resource of the first set of time-frequency resources, wherein the second signal is transmitted with the selected waveform.
Aspect 10: The method of any of aspects 1 through 9, further comprising: generating a first waveform over multiple slots for the second signal associated with sensing by repeating a second waveform configured over a single slot and based at least in part on selecting a first time-frequency resource of the first set of time-frequency resources, wherein the second signal is transmitted based at least in part on generating the first waveform.
Aspect 11: The method of any of aspects 1 through 10, wherein the second sidelink control information comprises a time resource indication value field, a frequency resource indication value field, or both indicating a first time-frequency resource of the first set of time-frequency resources.
Aspect 12: The method of aspect 11, wherein the time resource indication value field, the frequency resource indication value field, or both comprises an indication of whether the first time-frequency resource is reserved or available for a transmission distinct from the second signal associated with sensing.
Aspect 13: The method of any of aspects 1 through 12, wherein the second set of time-frequency resources includes a first time-frequency resource of the first set of time-frequency resources based at least in part on a duration associated with the second signal satisfying a first threshold, a power associated with the second signal satisfying a second threshold, or both.
Aspect 14: A method for wireless communication at a first UE, comprising: receiving first sidelink control information indicating that a second UE has selected a first set of time-frequency resources from a sidelink resource pool for transmitting a first signal associated with sidelink communication; transmitting, subsequent to receiving the first sidelink control information, a second signal associated with sensing using a second set of time-frequency resources of the sidelink resource pool, wherein the second set of time-frequency resources at least partially overlap with the first set of time-frequency resources, and wherein selecting the second set of time-frequency resources is based at least in part on a metric associated with the first time-frequency resources.
Aspect 15: The method of aspect 14, further comprising: randomly selecting, for the second set of time-frequency resources, a first time-frequency resource of the first set of time-frequency resources.
Aspect 16: The method of any of aspects 14 through 15, wherein the first time-frequency resource is selected for the second set of time-frequency resources based at least in part on a total number of monitored and non-reserved resources within a resource window associated with the sidelink resource pool being below a threshold.
Aspect 17: The method of any of aspects 14 through 16, further comprising: selecting, for the second set of time-frequency resources, a first time-frequency resource of the first set of time-frequency resources based at least in part on the first time-frequency resource being associated with a reference signal received power above a threshold power, a total duration of the first set of time-frequency resources overlapping with a total duration of the second set of time-frequency resources for less than a threshold amount of slots or symbols, or both.
Aspect 18: A method for wireless communication at a first UE, comprising: receiving first sidelink control information indicating that a second UE has selected a first time-frequency resource for transmitting a first signal associated with sidelink communication; receiving second sidelink control information indicating that a third UE has selected at least the first time-frequency resource for transmitting a second signal associated with sensing; and performing interference cancellation on the second signal associated with sensing to receive the first signal associated with sidelink communication over the first time-frequency resource based at least in part on receiving the second sidelink control information indicating that the third UE has selected the first time-frequency resource.
Aspect 19: The method of aspect 18, further comprising: determining a waveform of the second signal associated with sensing from a preconfigured set of waveforms, wherein performing the interference cancellation is based at least in part on determining the waveform.
Aspect 20: The method of any of aspects 18 through 19, wherein the waveform of the second signal is configured for a single slot and repeated over multiple slots, and performing the interference cancellation is based at least in part on the waveform of the second signal being configured for the single slot and repeated over the multiple slots.
Aspect 21: The method of any of aspects 18 through 20, further comprising: receiving an indication of a set of resources elements for detecting signals associated with sensing; detecting at least one signal associated with sensing over at least one of the set of resource elements, wherein performing the interference cancellation is based at least in part on detecting the at least one signal associated with sensing over the at least one of the set of resource elements.
Aspect 22: The method of aspect 21, wherein the set of resource elements excludes any resource elements configured for receiving one or more demodulation reference signals of one or more transmissions unassociated with sensing.
Aspect 23: The method of any of aspects 18 through 22, wherein the second sidelink control information comprises a time resource indication value field, a frequency resource indication value field, or both indicating the first time-frequency resource.
Aspect 24: The method of aspect 23, wherein the time resource indication value field, the frequency resource indication value field, or both comprises an indication of whether the first time-frequency resource is reserved or available for a transmission distinct from the second signal associated with sensing.
Aspect 25: An apparatus for wireless communication at a first UE, comprising a processor; memory coupled with the processor; and instructions stored in the memory and executable by the processor to cause the apparatus to perform a method of any of aspects 1 through 13.
Aspect 26: An apparatus for wireless communication at a first UE, comprising at least one means for performing a method of any of aspects 1 through 13.
Aspect 27: A non-transitory computer-readable medium storing code for wireless communication at a first UE, the code comprising instructions executable by a processor to perform a method of any of aspects 1 through 13.
Aspect 28: An apparatus for wireless communication at a first UE, comprising a processor; memory coupled with the processor; and instructions stored in the memory and executable by the processor to cause the apparatus to perform a method of any of aspects 14 through 17.
Aspect 29: An apparatus for wireless communication at a first UE, comprising at least one means for performing a method of any of aspects 14 through 17.
Aspect 30: A non-transitory computer-readable medium storing code for wireless communication at a first UE, the code comprising instructions executable by a processor to perform a method of any of aspects 14 through 17.
Aspect 31: An apparatus for wireless communication at a first UE, comprising a processor; memory coupled with the processor; and instructions stored in the memory and executable by the processor to cause the apparatus to perform a method of any of aspects 18 through 24.
Aspect 32: An apparatus for wireless communication at a first UE, comprising at least one means for performing a method of any of aspects 18 through 24.
Aspect 33: A non-transitory computer-readable medium storing code for wireless communication at a first UE, the code comprising instructions executable by a processor to perform a method of any of aspects 18 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a first user equipment (UE), comprising:
receiving first sidelink control information indicating that a second UE has selected a first set of time-frequency resources from a sidelink resource pool for transmitting a first signal associated with sidelink communication;
transmitting, subsequent to receiving the first sidelink control information, second sidelink control information indicating that the first UE has selected a second set of time-frequency resources from the sidelink resource pool for transmitting a second signal associated with sensing, wherein the second set of time-frequency resources at least partially overlap with the first set of time-frequency resources; and
transmitting the second signal using the second set of time-frequency resources based at least in part on transmitting the second sidelink control information.

2. The method of claim 1, further comprising:
randomly selecting, for the second set of time-frequency resources, a first time-frequency resource of the first set of time-frequency resources.

3. The method of claim 2, wherein the first time-frequency resource is selected for the second set of time-frequency resources based at least in part on a total number of monitored and non-reserved resources within a resource window associated with the sidelink resource pool being below a threshold.

4. The method of claim 1, further comprising:
selecting, for the second set of time-frequency resources, a first time-frequency resource of the first set of time-frequency resources based at least in part on the first time-frequency resource being associated with a reference signal received power above a threshold power, a total duration of the first time-frequency resource overlapping with a total duration of the second set of time-frequency resources for less than a threshold amount of slots or symbols, or both.

5. The method of claim 1, further comprising:
receiving third sidelink control information indicating that the second UE or a third UE has selected a third set of time-frequency resources from the sidelink resource pool for transmitting a third signal associated with sensing;
selecting, for a fourth set of time-frequency resources, a second time-frequency resource of the third set of time-frequency resources;
transmitting fourth sidelink control information indicating that the first UE has selected the fourth set of time-frequency resources from the sidelink resource pool for transmitting a fourth signal associated with sidelink communication; and
transmitting the fourth signal using the fourth set of time-frequency resources.

6. The method of claim 1, further comprising;
receiving third sidelink control information indicating that the second UE or a third UE has selected a third set of time-frequency resources from the sidelink resource pool for transmitting a third signal associated with sensing;
selecting, for a fourth set of time-frequency resources, a second time-frequency resource excluded from the third set of time-frequency resources based at least in part on a congestion level, a priority of a fourth signal associated with sidelink communication, packet delay budget of the fourth signal, an interference level associated with the third sidelink control information, or any combination thereof;
transmitting fourth sidelink control information indicating that the first UE has selected the fourth set of time-frequency resources from the sidelink resource pool for transmitting the fourth signal associated with sidelink communication, and
transmitting the fourth signal using the fourth set of time-frequency resources.

7. An apparatus for wireless communication at a first user equipment (UE), comprising:
one or more processors;
one or more memories coupled with the one or more processors; and
instructions stored in the one or more memories memory and executable by the one or more processors to cause the apparatus to:
receive first sidelink control information indicating that a second UE has selected a first set of time-frequency resources from a sidelink resource pool for transmitting a first signal associated with sidelink communication;
transmit, subsequent to receiving the first sidelink control information, second sidelink control information indicating that the first UE has selected a second set of time-frequency resources from the sidelink resource pool for transmitting a second signal associated with sensing, wherein the second set of time-frequency resources at least partially overlap with the first set of time-frequency resources; and
transmit the second signal using the second set of time-frequency resources based at least in part on transmitting the second sidelink control information.

8. The apparatus of claim 7, wherein the instructions are further executable by the one or more processors to cause the apparatus to:
randomly select, for the second set of time-frequency resources, a first time-frequency resource of the first set of time-frequency resources.

9. The apparatus of claim 8, wherein the first time-frequency resource is selected for the second set of time-frequency resources based at least in part on a total number of monitored and non-reserved resources within a resource window associated with the sidelink resource pool being below a threshold.

10. The apparatus of claim 7, wherein the instructions are further executable by the one or more processors to cause the apparatus to:
select, for the second set of time-frequency resources, a first time-frequency resource of the first set of time-frequency resources based at least in part on the first time-frequency resource being associated with a reference signal received power above a threshold power, a total duration of the first time-frequency resource overlapping with a total duration of the second set of time-frequency resources for less than a threshold amount of slots or symbols, or both.

11. The apparatus of claim 7, wherein the instructions are further executable by the one or more processors to cause the apparatus to:
receive third sidelink control information indicating that the second UE or a third UE has selected a third set of time-frequency resources from the sidelink resource pool for transmitting a third signal associated with sensing;
select, for a fourth set of time-frequency resources, a second time-frequency resource of the third set of time-frequency resources;
transmit fourth sidelink control information indicating that the first UE has selected the fourth set of time-frequency resources from the sidelink resource pool for transmitting a fourth signal associated with sidelink communication; and
transmit the fourth signal using the fourth set of time-frequency resources.

12. The apparatus of claim 7, wherein the instructions are further executable by the one or more processors to cause the apparatus to:
receive third sidelink control information indicating that the second UE or a third UE has selected a third set of time-frequency resources from the sidelink resource pool for transmitting a third signal associated with sensing;
select, for a fourth set of time-frequency resources, a second time-frequency resource excluded from the third set of time-frequency resources based at least in part on a congestion level, a priority of a fourth signal associated with sidelink communication, packet delay budget of the fourth signal, an interference level associated with the third sidelink control information, or any combination thereof;
transmit fourth sidelink control information indicating that the first UE has selected the fourth set of time-frequency resources from the sidelink resource pool for transmitting the fourth signal associated with sidelink communication, and
transmit the fourth signal using the fourth set of time-frequency resources.

13. The apparatus of claim 7, wherein the instructions are further executable by the one or more processors to cause the apparatus to:
receive third sidelink control information indicating that that a third UE has selected a third set of time-frequency resources for transmitting a third signal associated with sensing, the second set of time-frequency resources excluding each resource of the third set of time-frequency resources based at least in part on receiving the third sidelink control information.

14. The apparatus of claim 7, wherein the instructions are further executable by the one or more processors to cause the apparatus to:
receive third sidelink control information indicating that a third UE has selected a third set of time-frequency resources for transmitting a third signal associated with sensing, the second set of time-frequency resources comprising a first time-frequency resource of the third set of time-frequency resources based at least in part on less than a threshold percentage of the time-frequency resources of the third set of time-frequency resources overlapping with the time-frequency resources of the second set of time-frequency resources, the third set of time-frequency resources being associated with a reference signal received power below a threshold power, or both.

15. The apparatus of claim 7, wherein the instructions are further executable by the one or more processors to cause the apparatus to:
select a waveform for the second signal associated with the sensing from a preconfigured set of waveforms based at least in part on selecting a first time-frequency resource of the first set of time-frequency resources, wherein the second signal is transmitted with the selected waveform.

16. The apparatus of claim 7, wherein the instructions are further executable by the one or more processors to cause the apparatus to:
generate a first waveform over multiple slots for the second signal associated with sensing by repeating a second waveform configured over a single slot and based at least in part on selecting a first time-frequency resource of the first set of time-frequency resources, wherein the second signal is transmitted based at least in part on generating the first waveform.

17. The apparatus of claim 7, wherein the second sidelink control information comprises a time resource indication value field, a frequency resource indication value field, or both indicating a first time-frequency resource of the first set of time-frequency resources.

18. The apparatus of claim 17, wherein the time resource indication value field, the frequency resource indication value field, or both comprises an indication of whether the first time-frequency resource is reserved or available for a transmission distinct from the second signal associated with sensing.

19. The apparatus of claim 7, wherein the second set of time-frequency resources includes a first time-frequency resource of the first set of time-frequency resources based at least in part on a duration associated with the second signal satisfying a first threshold, a power associated with the second signal satisfying a second threshold, or both.

20. An apparatus for wireless communication at a first user equipment (UE), comprising:
one or more processors;
one or more memories coupled with the one or more processors; and
instructions stored in the one or more memories and executable by the one or more processors to cause the apparatus to:
receive first sidelink control information indicating that a second UE has selected a first set of time-frequency resources from a sidelink resource pool for transmitting a first signal associated with sidelink communication; and
transmit, subsequent to receiving the first sidelink control information, a second signal associated with sensing using a second set of time-frequency resources of the sidelink resource pool, wherein the second set of time-frequency resources at least partially overlap with the first set of time-frequency resources, and wherein selecting the second set of time-frequency resources is based at least in part on a metric associated with the first set of time-frequency resources.

21-30. (canceled)
